(19) United States
(12) Patent Application Publication
(10) Pub. No.: US 2009/0207246 A1
(43) Pub. Date: Aug. 20, 2009

(54) Interactive image acquisition device

(76) Inventors: Masahiko Inami, Tokyo (JP); Dairoku Sekiguchi, Tokyo (JP); Hiroki Mori, Saitama (JP); Shigesumi Kuwashima, Tokyo (JP); Fumitoshi Matsuno, Kanagawa (JP)

Correspondence Address: William S Frommer;Frommer Lawrence & Haug, 745 Fifth Avenue, New York, NY, 10151, US

(21) Appl. No.: 11/989,625

(22) PCT Filed: Jul. 28, 2006
(86) PCT No.: PCT/JP2006/315438

§ 371 Date: Jan. 28, 2008

(30) Foreign Application Priority Data
Jul. 29, 2005 (JP) 2005-221728

(51) Int. Cl. H04N 7/18; G06K 9/00

(52) U.S. Cl. 348/135; 382/154; 348/E07.086

(57) ABSTRACT

The present invention tracks a specified target object and provides an image in real time in a way that gives a viewer a sense of reality. The present invention connects, in order to produce a spherical image Q1, the images captured by cameras 13 that can move in a space and are arranged so as to take images of different directions such that the images captured by at least two or more image pickup elements are partially overlapped with one another, calculates a positional correlation between the spherical image Q1 and the target object specified from the images, and then arranges the target object substantially at the center of the spherical image Q1 in accordance with the positional correlation. This provides a tracking image that tracks and focuses on the target object out of the spherical image Q1.

### TECHNICAL FIELD

The present invention relates to an interactive image acquisition device, and is preferably applied for a tracking display, in which a desired object is tracked from images taken by an omnidirectional camera placed over the surface of a spherical body, for example.

### BACKGROUND ART

At present, many cameras are spread in our living space such as a station or a street corner. In addition, camera-attached cell phones and the like have become popular. Those devices help constitute a “ubiquitous” space in our society. However, many of those cameras are fixed on particular positions in a space for fixed-point surveillance.

It is a common practice in academic field that a plurality of cameras whose positions are already known are connected each other via a network and the images taken by the cameras are analyzed to track a particular object. Particularly, the Carnegie Mellon University is trying to create an image seen from a certain viewpoint by using many fixed cameras around stadium seats.

But all the methods use fixed cameras and the distance between the camera and the object can be long. This could lead to reduction in resolution. Moreover, it takes enormous calculation to combine images taken by a plurality of cameras into an image seen from a certain viewpoint in real time.

A plurality of cameras mounted on a moving object have been studied as part of the mixed-reality experiment, in which a plurality of cameras are mounted on an automobile for archiving omnidirectional images in a city: The images are combined from those taken by the cameras. Although omnidirectional images can be acquired at each location, technique for stabilizing cameras in order to prevent blurring of images due to moving objects' movement and how to disperse cameras have not been studied yet.

On the other hand, there is a three-dimensional shape generation device that includes a camera on a vehicle. While the vehicle is moving, the camera takes an image of an object. The three-dimensional shape generation device extracts three-dimensional information from the image and generates a three-dimensional map (see Patent Document 1, for example).

Furthermore, a study has been conducted on how to periodically acquire images by a camera attached to a person. However, it is just for recording his/her daily life or life log.

### Patent Document 1: Japanese Patent Laid-Open Publication No. 2005-115420

However, when many fixed cameras are placed in a stadium to produce an image seen from a certain viewpoint, the distance between a fixed camera and an object can be very long, leading to reduction in resolution. This cannot provide a viewer with an image that presents a sense of reality as if it tracks his/her desired object near the object.

### DISCLOSURE OF THE INVENTION

The present invention has been made in view of the above points and is intended to provide an interactive image acquisition device that can provide an image in real time in a way that gives a viewer a sense of reality by tracking a specified object.

To solve the above problem, an taken-image processing device of the present invention performs the process of connecting the images captured by image pickup elements that can move in a space and are arranged so as to take images of different directions such that the images captured by at least two or more image pickup elements are partially overlapped with one another; specifying a desired target object from the image captured by the image pickup elements; calculating a positional correlation between a connection image produced by connecting the images and the target object specified; and arranging the target object substantially at the center of the connection image in accordance with the positional correlation.

In that manner, the connection image is generated by connecting the images captured by the image pickup elements that are arranged to take images of different directions. Based on the positional correlation between the target object specified from the connection image and the connection image, the target object can be placed substantially at the center of the connection image. This provides the image that tracks and focuses on the target object on the connection image.

Moreover, an taken-image processing device of the present invention includes a plurality of image pickup elements that can move in a space and are arranged so as to take images of different directions such that the images captured by at least two or more image pickup elements are partially overlapped with one another; image connection means for connecting the images captured by the image pickup elements; target specification means for specifying a desired target object from the image captured by the image pickup elements; power supply means for supplying driving electric power to the image pickup elements; and image processing means for calculating a positional correlation between a connection image that the image connection means produced by connecting the images and the target object specified by the target specification means and arranging the target object substantially at the center of the connection image in accordance with the positional correlation.

In that manner, with the driving electric power supplied from the power supply means, the device operates independently. The connection image is generated by connecting the images captured by the image pickup elements that are arranged to take images of different directions. Based on the positional correlation between the target object specified from the connection image and the connection image, the target object can be placed substantially at the center of the connection image. This provides the image that tracks and focuses on the target object on the connection image.

Furthermore, an taken-image processing device of the present invention includes a plurality of image pickup elements that are placed at a predetermined place to be observed and are arranged so as to take images of different directions such that the images captured by at least two or more image pickup elements are partially overlapped with one another; image connection means for connecting the images captured by the image pickup elements; target specification means for specifying a desired target object from the image captured by the image pickup elements; and image processing means for calculating a positional correlation between a connection image that the image connection means produced by connecting the images and the target object specified by the target specification means and arranging the target object substantially at the center of the connection image in accordance with the positional correlation.

In that manner, the device is placed at a predetermined place to be observed. The connection image depicting that place is generated by connecting the images captured by the image pickup elements that are arranged to take images of different directions. Based on the positional correlation between the target object (which exists in an area to be observed) specified from the connection image and the connection image, the target object can be placed substantially at the center of the connection image. This provides the image that tracks and focuses on the target object on the connection image depicting that place.

According to the present invention, the connection image is generated by connecting the images captured by the image pickup elements that are arranged to take images of different directions. Based on the positional correlation between the target object specified from the connection image and the connection image, the target object can be placed substantially at the center of the connection image. That realizes a taken-image processing device and taken-image processing method that can provide an image in real time in a way that gives a viewer a sense of reality by tracking the specified object on the connection image.

Moreover, according to the present invention, with the driving electric power supplied from the power supply means, the device operates independently. The connection image is generated by connecting the images captured by the image pickup elements that are arranged to take images of different directions. Based on the positional correlation between the target object specified from the connection image and the connection image, the target object can be placed substantially at the center of the connection image. That realizes a taken-image processing device that can provide an image in real time in a way that gives a viewer a sense of reality by tracking the specified object on the connection image.

Furthermore, according to the present invention, the device is placed at a predetermined place to be observed. The connection image depicting that place is generated by connecting the images captured by the image pickup elements that are arranged to take images of different directions. Based on the positional correlation between the target object (which exists in an area to be observed) specified from the connection image and the connection image, the target object can be placed substantially at the center of the connection image. That realizes a taken-image processing device that can provide an image in real time in a way that gives a viewer a sense of reality by tracking the specified object on the connection image depicting that place.

### BRIEF DESCRIPTION OF THE DRAWINGS

FIG. 1 is a schematic diagram illustrating an object-surface-dispersed camera.

FIG. 2 is a schematic diagram illustrating a source and output of an object-surface-dispersed camera.

FIG. 3 is a schematic diagram illustrating a spherical image.

FIG. 4 is a schematic diagram illustrating a two-dimensional image extracted from a spherical image.

FIG. 5 is a schematic diagram illustrating an indoor situation surveillance system according to a first embodiment of the present invention.

FIG. 6 is a schematic block diagram illustrating the circuit configuration of an indoor situation confirmation ball.

FIG. 7 is a schematic block diagram illustrating the circuit configuration of a rotation calculation section.

FIG. 8 is a schematic diagram illustrating a template.

FIG. 9 is a schematic diagram illustrating an example of an appropriate template.

FIG. 10 is a schematic diagram illustrating an example of an inappropriate template.

FIG. 11 is a schematic diagram illustrating how to calculate a difference between templates.

FIG. 12 is a flowchart illustrating a procedure of rotation calculation process by optical flow.

FIG. 13 is a schematic block diagram illustrating the configuration of a tracking section (when a color is specified).

FIG. 14 is a schematic diagram illustrating an object area and its center-of-gravity point.

FIG. 15 is a schematic block diagram illustrating the configuration of a tracking section (when a pattern is specified).

FIG. 16 is a flowchart illustrating a procedure of tracking process for a plurality of targets.

FIG. 17 is a schematic diagram illustrating the configuration of a capsule endoscope system according to a second embodiment of the present invention.

FIG. 18 is a schematic diagram illustrating the driving force of a capsule endoscope.

FIG. 19 is a schematic block diagram illustrating the circuit configuration of a capsule endoscope.

FIG. 20 is a schematic diagram illustrating the configuration of a security system according to a third embodiment of the present invention.

FIG. 21 is a schematic block diagram illustrating the circuit configuration of a security system.

FIG. 22 is a schematic block diagram illustrating the circuit configuration of an indoor situation confirmation ball according to other embodiments.

FIG. 23 is a schematic diagram illustrating the configuration of a camera-attached soccer ball according to other embodiments.

FIG. 24 is a schematic diagram illustrating the configuration of a camera-attached headband according to other embodiments.

FIG. 25 is a schematic diagram illustrating the configuration of an object-surface-dispersed camera according to other embodiments.

### BEST MODE FOR CARRYING OUT THE INVENTION

An embodiment of the present invention will be described in detail with reference to the accompanying drawings.

### (1) Basic Concept of the Present Invention

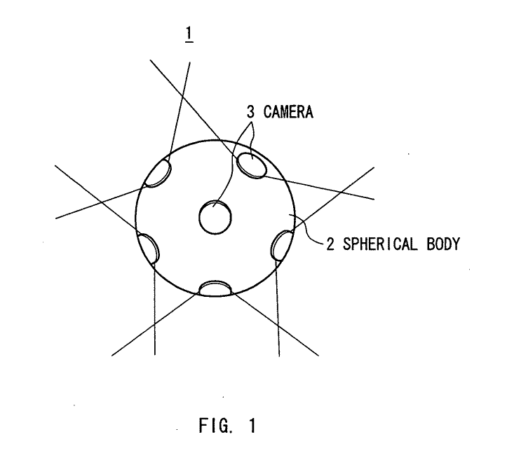

A taken-image processing device, or an interactive image acquisition device of the present invention, uses a object-surface-dispersed camera 1 that for example includes, as shown in FIG. 1, a spherical body 2 and a plurality of cameras (CCD (Charge Coupled Device) image pickup elements, for example) 3: The cameras 3 are mounted on the surface of the spherical body 2 so as to take omnidirectional images covering all directions around the spherical body 2. The object-surface-dispersed camera 1 is placed at center of the site. The object-surface-dispersed camera 1 moves or rotates to take omnidirectional images by the cameras 3 and combines them in real time. This produces an aerial image as if actually viewed by a viewer. His/her desired object on the image is tracked for tracking display.

By the way, humans have two eyes but can only recognize one aerial image. It is considered that both jumping spiders with eight eyes and scallops with a myriad of eyes on its mantle recognize one aerial image.

Fisheye lens and rotational hyperboloid mirrors have been used to acquire omnidirectional images. However, they are not good at improving resolution because they only use one camera to take omnidirectional images. By contrast, one of the features of the present invention is that it uses the object-surface-dispersed camera 1 that includes a plurality of cameras on the surface of the body like scallop's eyes on a mantle.

Especially, in order to obtain omnidirectional images, the object-surface-dispersed camera 1 is configured such that images taken by at least two or more cameras 3 are partially overlapped with each other. In addition, the cameras 3 can move in a space because the object-surface-dispersed camera 1 is a ball that can roll.

People can avoid blurring of images they recognize when they move their heads, by correcting the movement of retinal images in accordance with angular movement information from a vestibular organ and optical flow information on the retina.

The taken-image processing device of the present invention uses the object-surface-dispersed camera 1 that can move or roll in various ways to acquire an omnidirectional image around the site in real time in a way that provides a person with an easy-to-understand form with a sense of reality.

That is, the taken-image processing device of the present invention corrects blurring of omnidirectional images caused by the movements or rotational movements in accordance with optical flow information of the omnidirectional images (i.e. the images covering a plurality of directions) acquired from the cameras 3, angular velocity information detected by gyro sensors or the like attached to the cameras 3 or the like. This presents an eye-friendly, easy-to-understand image as if a viewer is taking a picture by using one camera without shifting his/her position.

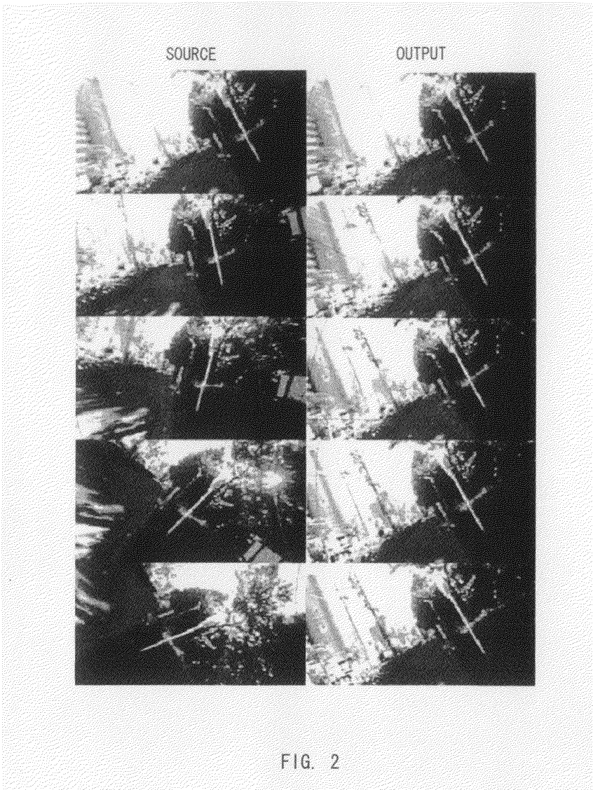

In fact, in the taken-image processing device, as shown in the left side (Source) of FIG. 2 illustrating an image seen from a particular direction, which was acquired from one of the cameras 3 when the object-surface-dispersed camera 1 rotates, as its frame proceeds the image rolls. Correcting the effect of rolling presents eye-friendly, easy-to-understand images as shown in the right side (Output) of FIG. 2, as if a viewer is taking a picture by using one camera without shifting his/her position.

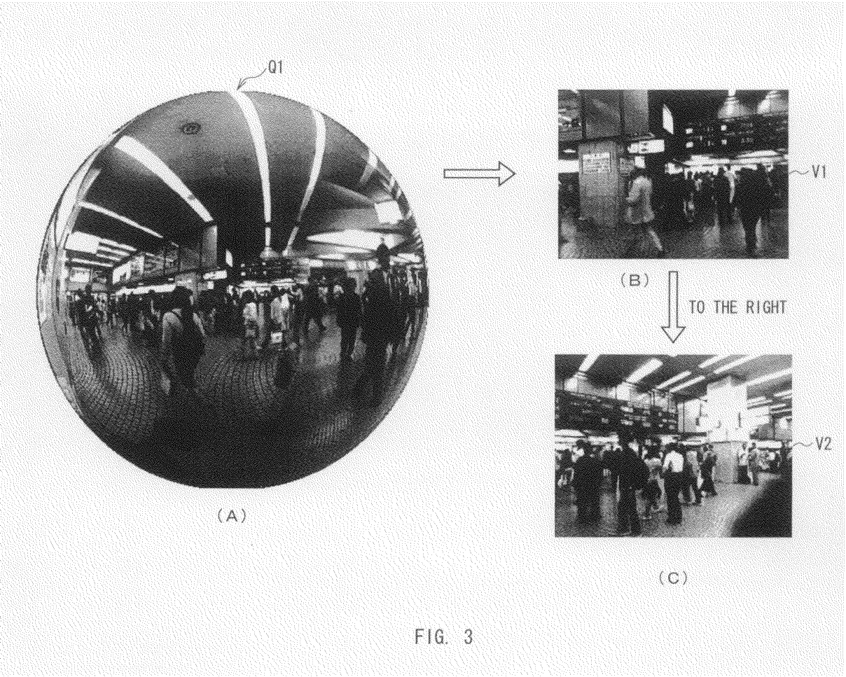

Especially, in the taken-image processing device of the present invention, when taking an image of an object, the object-surface-dispersed camera 1 moves or rolls while the cameras 3 takes omnidirectional images, which are then corrected to eliminate the effect of rolling and combined as if they are seamlessly attached to the surface of a spherical object, producing a spherical image Q1 as shown in FIG. 3(A).

Subsequently, as shown in FIG. 3(B), the taken-image processing device clips from the spherical image Q1 a portion that includes what a viewer wants to watch as a two-dimensional image V1. The two-dimensional image V1 may be displayed on a display. Alternatively, as shown in FIG. 3(C), the two-dimensional image V1 may be replaced with another two-dimensional image V2 as if its line of vision was shifted to, for example, the right direction after a viewer operates an image specification device such as joy-stick. In this manner, an “arbitrary-line-of-vision image” can be offered as if a viewer arbitrarily changes his/her line of vision.

The “arbitrary-line-of-vision image” is an image like what a viewer sees a portion of the omnidirectional image attached to a spherical object of the spherical image Q1, when a person is considered to be positioned, for example, at the center of the spherical image Q1 and then looks around with changing his/her line of vision at will. It is a part of a three-dimensional space the viewer observes.

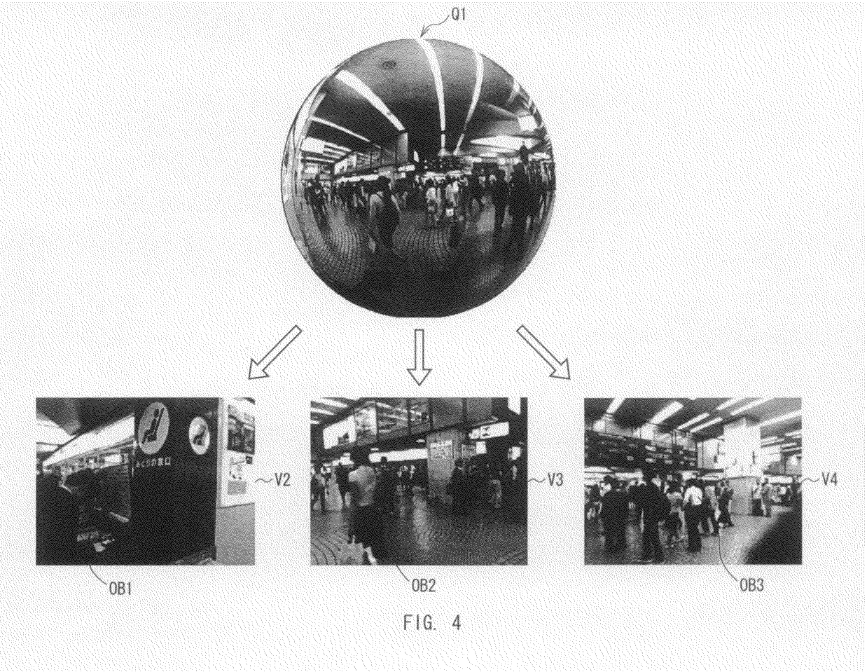

In addition, the taken-image processing device of the present invention can offer tracking display because the spherical image Q1 covers all directions around the spherical body 2 from a spatial point of view: As shown in FIG. 4, the taken-image processing device can clip and display two-dimensional images V2, V3, and V4, which include objects OB1, OB2, and OB3 three viewers for example like to observe, and continue to update them as if tracking the objects OB1, OB2, and OB3.

There could be various applications of the above taken-image processing device. The following describes an indoor situation surveillance system, capsule endoscope system and security system that employ the taken-image processing device.

### (2) First Embodiment

### (2-1) Overall Configuration of Indoor Situation Surveillance System According to First Embodiment

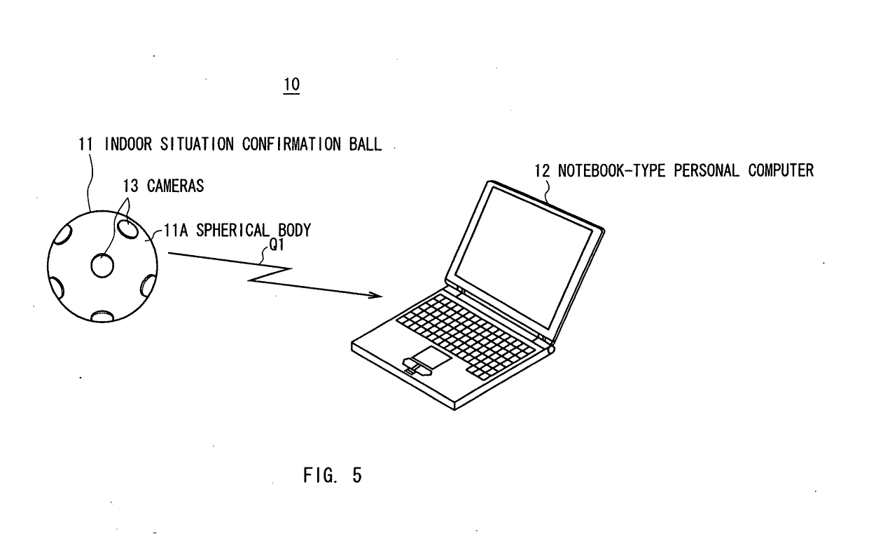

In FIG. 5, the reference numeral 10 denotes an indoor situation surveillance system according to a first embodiment of the present invention. The indoor situation surveillance system 10 includes an indoor situation confirmation ball 11 (which is the equivalent of the object-surface-dispersed camera 1 (FIG. 1)) that takes omnidirectional images and combines them to create the spherical image Q1 (FIGS. 3 and 4); and a notebook-type personal computer (also referred to as a “note PC”) 12, which wirelessly receives the spherical image Q1 and displays it.

The indoor situation confirmation ball 11 has n cameras 13 on its spherical body 11A's surface so that the cameras 13 can take omnidirectional images (a plurality of images in different directions). The positional correlation for connecting images has been calibrated.

By the way, the indoor situation confirmation ball 11 does not have to acquire omnidirectional images: The indoor situation confirmation ball 11 should acquire at least a predetermined number of images in different directions so that it can generate the spherical image Q1. In addition, the optical axes of the n cameras 13 may not be aligned with lines that extend from the center of the spherical body 11A in a radial pattern.

The indoor situation confirmation ball 11 can be thrown in a collapsed building after disaster or the like in order to look for survivors in the building. The spherical image Q1, generated from the omnidirectional images, may be transmitted to the note PC 12 via wireless or wired communication means. A viewer can visually check the situation inside the building through the spherical image Q1 displayed on the note PC 12 in real time.

### (2-2) Circuit Configuration of Indoor Situation Confirmation Ball

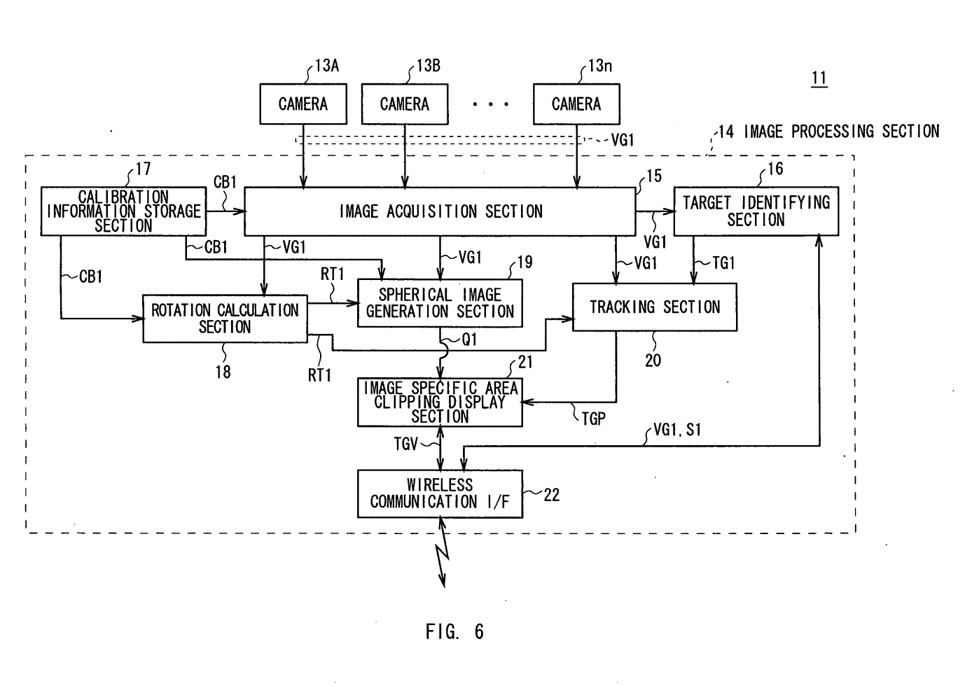

As shown in FIG. 6, the indoor situation confirmation ball 11 is powered by a battery (not shown). The indoor situation confirmation ball 11 inputs omnidirectional images acquired from the n cameras 13A to 13n into an image acquisition section 15 of an image processing section 14: Those omnidirectional images are a plurality of images in different directions and collectively referred to as image data group VG1. The image data group VG1 is supplied from the image acquisition section 15 to a target identifying section 16, a rotation calculation section 18, a spherical image generation section 19 and a tracking section 20.

The image processing section 14 includes a calibration information storage section 17 that supplies calibration information CB1 to the rotation calculation section 18 and the spherical image generation section 19.

The target identifying section 16 wirelessly transmits the image data group VG1 supplied from the image acquisition section 15 to the note PC 12 via a wireless communication interface 22 such as Bluetooth (Registered Trademark) or IEEE (Institute Of Electrical and Electronics Engineers) 802.11g.

The note PC 12 (FIG. 5) wirelessly receives from the indoor situation confirmation ball 11 the image data group VG1 and displays an image of indoor situation corresponding to the image data group VG1 on a display. The note PC 12 allows a viewer to specify his/her desired object (a person, for example) on the image through an image movement specification device such as a mouse and generates a specification signal S1 that indicates the object, which is then wirelessly transmitted to the indoor situation confirmation ball 11.

The image processing section 14 of the indoor situation confirmation ball 11 wirelessly receives from the note PC 12 via the wireless communication interface 22 the specification signal S1, which is then supplied to the target identifying section 16.

Based on the specification signal S1 supplied from the note PC 12, the target identifying section 16 identifies, from the image data group VG1 supplied from the image acquisition section 15, the object as a target based on a color or pattern specified by the viewer. The target identifying section 16 transmits a target identification signal TG1 that indicates the identified target to the tracking section 20.

On the other hand, the rotation calculation section 18 of the indoor situation confirmation ball 11 sequentially calculates how much, with reference to a reference image frame, the next frame has rotated when the indoor situation confirmation ball 11 moves or rotates, by using the calibration information CB1 supplied from the calibration information storage section 17 and the image data group VG1 supplied from the image acquisition section 15.

By the way, the calibration information CB1 is used to produce the spherical image Q1 (FIGS. 3 and 4). The calibration information CB1 includes geometric information to calibrate lens distortion of each camera 13A to 13n and information that represents connection-positional correlation for attaching or connecting a plurality of images of different directions acquired from the n cameras on the surface of the spherical body 11A. The spherical image generation section 19 of the image processing section 14 uses the calibration information CB1 to seamlessly connect the image data group VG1 (a plurality of images in different directions) supplied from the cameras 13. This produces the spherical image Q1 without distortion.

The calibration information storage section 17 has recognized the connection-positional correlation, which is used for connecting a plurality of images of different directions from the n cameras 13A to 13n, as the calibration information CB1. The calibration information CB1 can be calibrated later by a viewer. Especially, the images taken by the n cameras 13A to 13n are partially overlapped with one another. Those images are seamlessly connected based on the calibration information CB1, generating a connection image or the spherical image Q1.

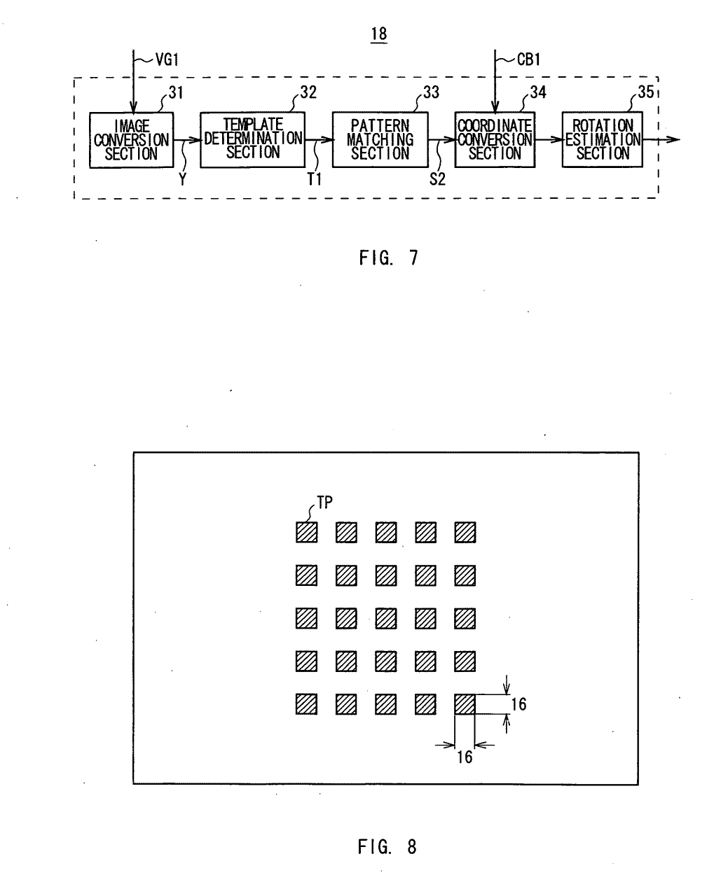

Actually, the rotation calculation section 18 inputs each image of the image data group VG1 supplied from the image acquisition section 15 into a image conversion section 31, as shown in FIG. 7. The image conversion section 31 converts the images of the image data group VG1 into 1024×768-pixel RGB signals and then into 512×384-pixel brightness signals Y, which are then transmitted to a template determination section 32.

The reason why the image conversion section 31 converts the RGB signals into the brightness signals Y is that using RGB signals for calculating rotation takes much more calculation time, and therefore the conversion can reduce calculation time. On the other hand, the RGB signals are stored separately.

As shown in FIG. 8, the template determination section 32 uses the brightness signals Y to check 16×16-pixel templates TP of a previous frame, which is one frame before the current frame, in order to determine whether they are appropriate for pattern matching: There are 25 templates in this case.

The template TP appropriate for pattern matching is a pattern that has a unique minimum value for pattern-matching search, including a relatively complex image.

By contrast, the template TP not appropriate for pattern matching is the one whose entire image area the camera captured is substantially at the same brightness level or the one including two different color areas that linearly border on one another or the like. It is difficult to find out from them a template whose correlation value becomes a unique minimum value during pattern matching.

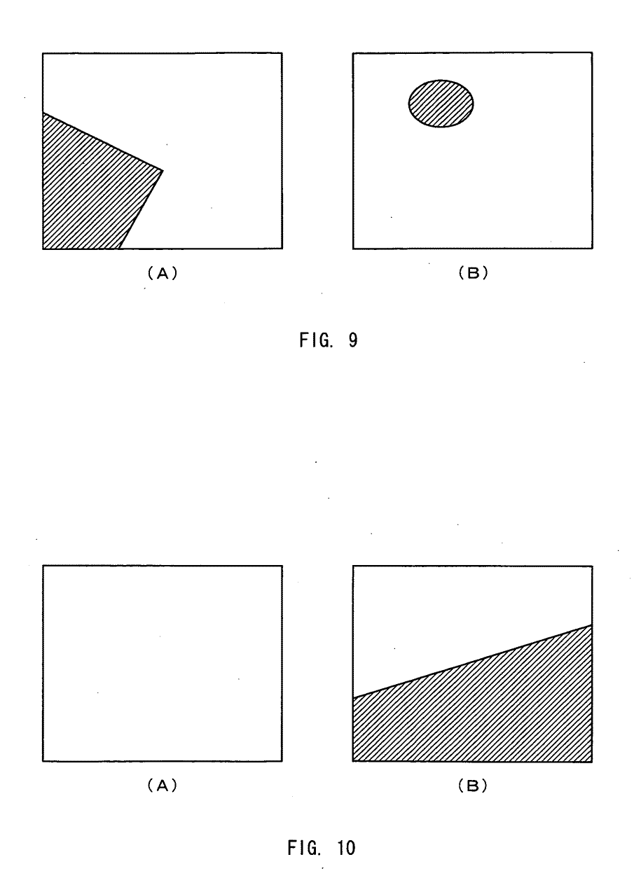

That is, if the images are relatively complex as shown in FIGS. 9(A) and 9(B), they are proper templates. If an image is monotone or an image just includes two different color areas that linearly border on one another as shown in FIGS. 10(A) and 10(B), they are not appropriate.

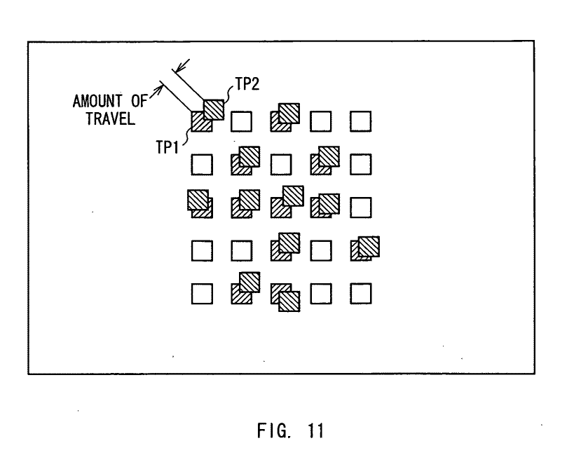

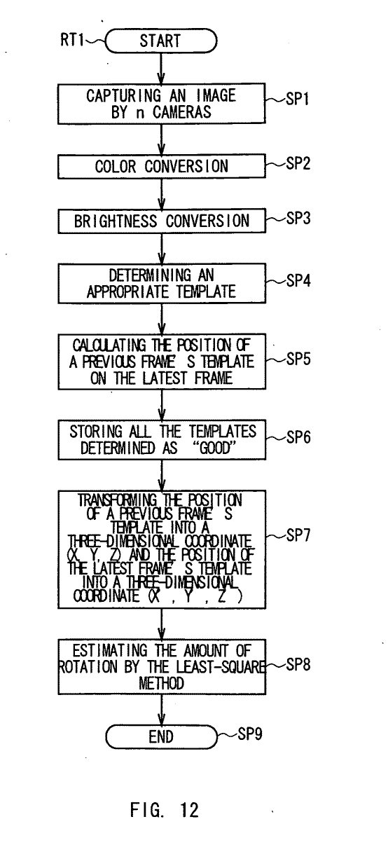

Pattern matching is performed by searching for a minimum value of SAD (Sum of Absolute Difference) based on the proper template TP1 of the previous frame as shown in FIG. 11 and detecting the position of a template TP2 corresponding to the template TP1 from the next frame (also referred to as latest frame) following the previous frame, or how far the template TP1 or TP2 has moved. This search has two stages, one for roughly searching by 4-pixel unit and the other for carefully searching by one-pixel unit, in order to speed up pattern matching.

The templates TP (TP1 and TP2) are usually positioned around the center of the image area the camera captured because, if they are set around the edge of the area, they can easily slip out from the nest frame. This prevents it from happening.

In that manner, the template determination section 32 selects from the 25 templates TP1 and TP2 the templates TP1 and TP2 appropriate for pattern matching, and then transmits template information T1 that indicates the selected templates TP1 and TP2 to a pattern matching section 33. By the way, the template determination section 32 at the time stores the template information T1 for the next frame.

The pattern matching section 33 only uses the appropriate templates TP1 and TP2 in accordance with the template information T1 supplied from the template determination section 32, and detects, by pattern matching, how far the previous frame's template TP1 or the latest frame's template TP2 has moved, as a travel distance. The detected result S2 is transmitted to a coordinate conversion section 34.

The coordinate conversion section 34 recognizes, based on the calibration information CB1 from the calibration information storage section 17, the connection-positional correlation for generating the spherical image Q1 as three-dimensional coordinates. The coordinate conversion section 34 converts the position of the previous frame's template TP1 into a three-dimensional coordinates (x, y, z) of the spherical image Q1 and the position of the latest frame's template TP2 (which is equal to “the position of the previous frame”+“the travel distance”) into a three-dimensional coordinates (x′, y′, z′) of the spherical image Q1. The previous frame's three-dimensional coordinates (x, y, z) and the latest frame's three-dimensional coordinates (x′, y′, z′) are transmitted to a rotation estimation section 35.

The rotation estimation section 35 for example assumes that the spherical image Q1 is a 2.5 meter radius ball on which a plurality of images acquired from the n cameras 13A to 13n are mapped. The rotation estimation section 35 is designed to figure out how the templates TP1 and TP2 have moved on the surface of the spherical image Q1.

In order to calculate the rotation in the three-dimensional coordinates, the rotation estimation section 35 assumes that the position of the previous frame's template TP1, before being rotated, is (x, y, z) and the position of the latest frame's template TP2, after being rotated, is (x′, y′, z′):

x′=cosA cosB+(cosB·sinA·sinC−sinA·cosC)y+(cosA·sinB·cosC+sinA·sinC)z (1)

y′=sinA·cosB+(sinA·sinB·sinC+cosA·cosC)y+(sinA·sinB·sinC−cosA·sinC)z (2)

z′=−sinB·x+cosB·sinC·y+cosB·cosC·z (3)

If there is a plurality of templates TP1 and TP2 that successfully went through pattern matching, there is a plurality of combinations of three-dimensional coordinates (x, y, z) and (x′, Y′, z′). Accordingly, least-square method can estimate the coefficients A, B, and C to calculate a rotation axis and a rotation angle. That is, the rotation estimation section 35 uses a simple model of linear transformation to realize high-speed least-square calculation.

The problem is that the combination of three-dimensional coordinates (x, y, z) and (x′, y′, z′) includes wrong data components. It includes wrong data components if pattern matching failed or there is an error due to change of the images under the following conditions: the first condition is that the images have been affected not only by the rotation of the cameras 13A to 13n but also by other factors such as the parallel movement of the cameras 13A to 13n or other moving objects; and the second condition is that the object is not adequately far away (more than several meters) from the cameras 13A to 13n (The error for a model of calibration becomes larger if the object is too much close to the cameras 13A to 13n because the centers of the lenses of the cameras 13A to 13n are at different positions). Therefore, it needs to eliminate those wrong data components.

That means the rotation estimation section 35 can estimate the amount of rotation between the previous frame and the latest frame by performing estimation with least-square method after eliminating wrong data components. In this manner, the amount of rotation is calculated and then transmitted to the spherical image generation section 19 and the tracking section 20 as rotation information RT1.

By the way, when calculating the amount of rotation of the latest frame, the rotation estimation section 35 needs to calculate not only the amount of rotation from the previous frame but also the total amount of rotation accumulated from the first reference frame.

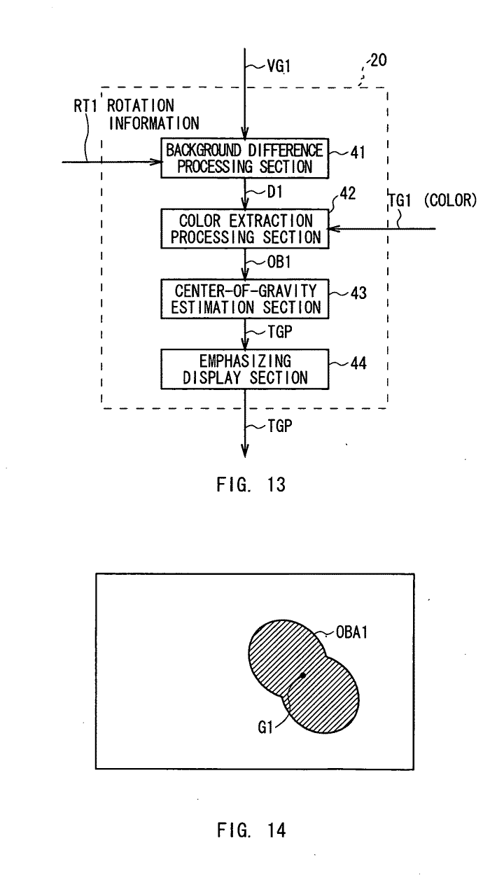

FIG. 12 is a flowchart illustrating such a rotation calculation process by the rotation calculation section 18 that uses optical flow. The rotation calculation section 18 starts a routine RT1 from a start step and proceeds to next step SP1. At step SP1, the rotation calculation section 18 acquires from the n cameras 13A to 13n the image data group VG1 (a plurality of images in different directions) and then proceeds to next step SP2.

At step SP2, the rotation calculation section 18 transforms, by using the image conversion section 31, the images of the image data group VG1 into 1024×768-pixel RGB signals. At subsequent step SP3, the rotation calculation section 18 converts, by using the image conversion section 31, the RGB signals into 512×384-pixel brightness signals Y, and then proceeds to next step SP4.

At step SP4, the rotation calculation section 18 checks, by using the brightness signals Y, the twenty-five 16×16-pixel templates TP of the previous frame in order to determine whether they are appropriate for pattern matching, and then proceeds to next step SP5.

At step SP5, after the previous frame's template TP1 was determined as an appropriate one at step SP4, the rotation calculation section 18 calculates a distance between the template TP1 and the corresponding template TP2 of the latest frame that follows the previous frame, or how much the template TP1 or TP2 has moved, and then proceeds to next step SP6.

At step SP6, the rotation calculation section 18 stores the latest frame's template TP2, which was determined at step SP4 as appropriate for pattern matching, in order to use it for the next pattern matching, and then proceeds to next step SP7.

At step SP7, the rotation calculation section 18 converts the position of the previous frame's template TP1 into a three-dimensional coordinates (x, y, z) and then, after rotation, transforms the position of the latest frame's template TP2 into a three-dimensional coordinates (x′, y′, z′). The rotation calculation section 18 subsequently proceeds to step SP8.

At step SP8, the rotation calculation section 18 estimates, as the rotation information RT1, the amount of rotation between frames by calculating the coefficients A, B, and C of the equations (1) to (3) by least-square method, and then proceeds to step SP9 to end the procedure of rotation calculation process.

The spherical image generation section 19 generates the spherical image Q1 by connecting the image data group's images captured by the n cameras 13A to 13n, based on the image data group VG1 supplied from the image acquisition section 15, the calibration information CB1 supplied from the calibration information storage section 17 and the rotation information RT1 supplied from the rotation calculation section 18. The spherical image generation section 19 subsequently supplies the spherical image Q1 to an image specific area clipping display section 21.

The tracking section 20 identifies the viewer's desired object from each image of the image data group VG1 for tracking display, based on the image data group VG1 supplied from the image acquisition section 15 and the target identification signal TG1 supplied from the target identifying section 16. The tracking section 20 subsequently transmits target position information TGP that indicates the target to the image specific area clipping display section 21.

To generate the target position information TGP, the tracking section 20 has different sets of circuit configuration for processing the target identification signal TG1 that specifies a color and the target identification signal TG1 that specifies a pattern: The target identification signals TG1 are supplied from the target identifying section 16.

As shown in FIG. 13, if the target identification signal TG1 is the one that specifies a color, the tracking section 20 supplies the image data group VG1 supplied from the image acquisition section 15 to a background difference processing section 41.

The background difference processing section 41 removes background image by calculating a difference between the previous frame's image and the latest frame's image, which are the images of the image data group VG1, in order to extract only moving image. The background difference processing section 41 subsequently transmits motion part data D1 representing the extracted moving image to a color extraction processing section 42.

By the way, the background difference processing section 41 is designed to remove background image by calculating a difference between the previous frame's image and the latest frame's image, which are the images of the image data group VG1, in order to extract only moving image. At this time, the background difference processing section 41 cancels the effect of rotation between the previous and latest frames based on the rotation information RT1 supplied from the rotation calculation section 18.

That reduces processing load of the background difference processing section 41 that removes background image by calculating a difference between the previous frame's image and the latest frame's image. This reduces processing load and calculation time for extracting motion part data D1.

The color extraction processing section 42 extracts from the motion part data D1 a object area OBA1 having the color that the target identification signal TG1 supplied from the target identifying section 16 specifies, and supplies the object area OBA1 to a center-of-gravity estimation section 43.

The center-of-gravity estimation section 43 estimates the center-of-gravity point G1 of the object area OBA1 and then supplies it to an emphasizing display section 44 as the target position information TGP that indicates the center of the object.

The emphasizing display section 44 recognizes the object area OBA1 from the target position information TGP, and performs an emphasizing display process (at least one of the following processes: a color-tone process, an edge enhancement process, and a contrasting process) to emphasize the object as the target of tracking. This allows a viewer to recognize it easily. The emphasizing display section 44 transmits the target position information TGP to the image specific area clipping display section 21.

The image specific area clipping display section 21 calculates a positional correlation between the spherical image Q1 generated by the spherical image generation section 19 and the object area OBA1 for which the tracking section 20 has performed an emphasizing display process by using the target position information TGP. Based on the positional correlation, the image specific area clipping display section 21 sets an image area corresponding to the object area OBA1 and places it such that the object area OBA1 is positioned around the center of the spherical image Q1 and then clips a portion of image around the object area OBA1 to generate a tracking image TGV that focuses on the object area OBA1. The image specific area clipping display section 21 then wirelessly transmits the tracking image TGV to the note PC 12 via the wireless communication interface 22.

By the way, if an object is not specified by a viewer (by color or pattern), the image specific area clipping display section 21 wirelessly transmits the spherical image Q1 supplied from the spherical image generation section 19 to the note PC 12 via the wireless communication interface 22.

If there is a plurality of objects specified, the note PC 12 (FIG. 5) generates each object's tracking image TGV and displays them on a display at the same time, allowing a viewer to visually check a plurality of tracking images TVG for a plurality of objects at the same time.

By the way, the image processing section 14 can wirelessly transmit the spherical image Q1 to the note PC 12 via the wireless communication interface 22. This allows a viewer to specify his/her desired object from the spherical image Q1 on a display of the note PC 12.

The note PC 12 (FIG. 5) holds identification information of the cameras 13A to 13n that output a plurality of images in different directions, which constitute the spherical image Q1. When ordered by a viewer, the note PC 12 temporarily holds the spherical image Q1 in the form of a still image. When a viewer specifies his/her desired object from the still image or the spherical image Q1, the note PC 12 wirelessly transmits a resulting specification signal S1 and the identification information to the indoor situation confirmation ball 11.

After receiving the specification signal S1 and the identification information via the wireless communication interface 22, the image processing section 14 of the indoor situation confirmation ball 11 identifies, by using the image specific area clipping display section 21, one of the cameras 13A to 13n outputting an image including the object area OBA1 of the object the specification signal S1 has specified, based on the identification information.

By using the cameras 13A to 13n identified by the identification information, the image specific area clipping display section 21 counts how many frames there are between the temporarily-held stationary spherical image Q1 and another spherical image received at the time when the specification signal S1 was received to recognize how it has moved over time. In this manner, the image specific area clipping display section 21 figures out the current position of the object area OBA1, which was specified by the specification signal S1, on the spherical image Q1.

Subsequently, the image specific area clipping display section 21 recognizes the current position of the object area OBA1 on the spherical image Q1, and then sets an image area corresponding to the object area OBA1 located at that position. The image specific area clipping display section 21 then clips out a portion of image, in which the object area OBA1 is positioned around the center of the spherical image Q1, in order to generate the tracking image TGV that focuses on the object area OBA1. The image specific area clipping display section 21 wirelessly transmits the tracking image TGV to the note PC 12 via the wireless communication interface 22.

In that manner, the note PC 12 displays on a display the tracking image that tracks, as a target, the object area OBA1 of the object that was specified on the stationary spherical image Q1. This allows a viewer to visually check the object in real time.

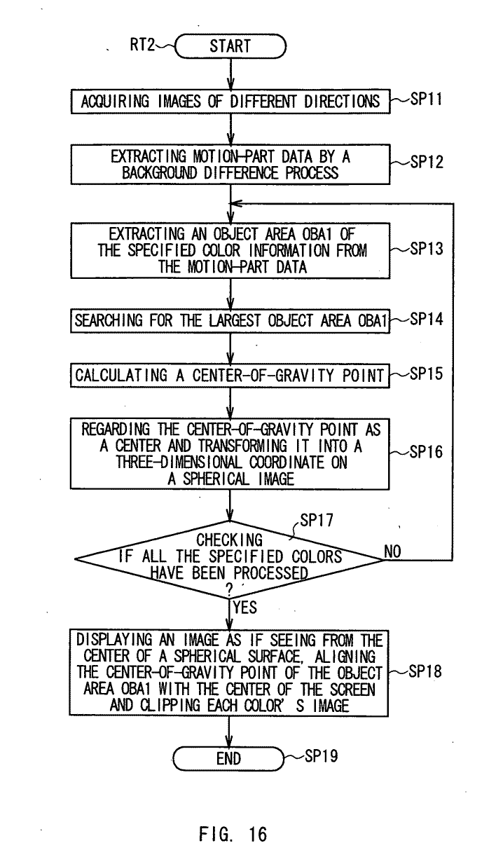

On the other hand, as shown in FIG. 15, if the target identification signal TG1 is the one that specifies a color, the tracking section 20 inputs the image data group VG1 supplied from the image acquisition section 15 into a pattern matching section 46.

The tracking section 20 also transmits the target identification signal TG1 supplied from the target identifying section 16 to a pattern update section 46, which follows the pattern matching section 46. The pattern update section 47 updates the pattern of the object specified by a viewer and then returns it to the pattern matching section 46: The object can be identified from the target identification signal TG1.

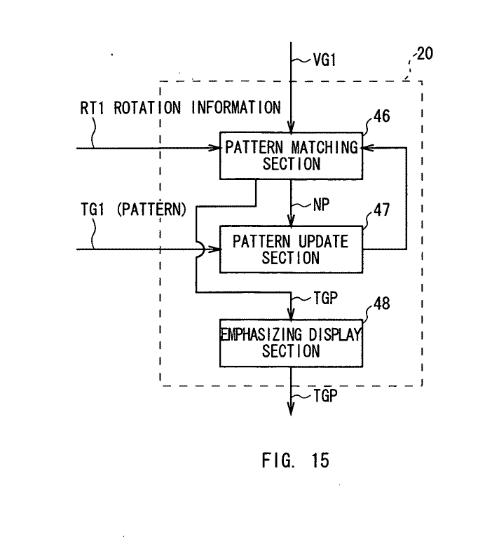

The pattern matching section 46 performs pattern matching for the latest frame's image of the image data group VG1 by using the pattern supplied from the pattern update section 47 in order to extract the object specified by a viewer. The pattern matching section 46 subsequently generates the target position information TGP that indicates the center-of-gravity point G1 of its object area OBA1 (FIG. 14) and transmits the target position information TGP to the emphasizing display section 48. The pattern matching section 46 also transmits the target position information TGP to the pattern update section 47 to update the pattern of the object area OBA1 as the latest pattern NP. The pattern of the object is updated again by the latest pattern NP.

By the way, the pattern matching section 46, like the background difference processing section 41 (FIG. 13), is designed to cancel the effect of rotation for the latest frame based on the rotation information RT1 supplied from the rotation calculation section 18, before performing pattern matching for the latest frame's image of the image data group VG1. In this manner, the pattern matching section 46 reduces processing load of pattern matching for the latest frame, decreasing processing load and calculation time.

The emphasizing display section 48 recognizes the object area OBA1 (FIG. 14) from the target position information TGP and performs an emphasizing display process (at least one of the following processes: a color-tone process, an edge enhancement process, and a contrasting process) to emphasize the object as the target of tracking. This allows a viewer to recognize it easily. The emphasizing display section 48 transmits the target position information TGP to the image specific area clipping display section 21.

The image specific area clipping display section 21 calculates a positional correlation between the spherical image Q1 generated by the spherical image generation section 19 and the object area OBA1 for which the tracking section 20 has performed an emphasizing display process by using the target position information TGP. Based on the positional correlation, the image specific area clipping display section 21 sets an image area corresponding to the object area OBA1 and places it such that the object area OBA1 is positioned around the center of the spherical image Q1 and then clips a portion of image around the object area OBA1 to generate a tracking image TGV that focuses on the object area OBA1. The image specific area clipping display section 21 then wirelessly transmits the tracking image TGV to the note PC 12 via the wireless communication interface 22.

By the way, if an object is not specified by a viewer (by color or pattern), the image specific area clipping display section 21 wirelessly transmits the spherical image Q1 supplied from the spherical image generation section 19 to the note PC 12 via the wireless communication interface 22.

If there is a plurality of objects specified, the image processing section 14 of the indoor situation confirmation ball 11 calculates positional correlations between a plurality of object areas OBA1 and omnidirectional images that constitute the spherical image Q1. Based on the positional correlations, the image processing section 14 places the object areas OBA1 such that each object area OBA1 is positioned around the center of the spherical image Q1 and then clips a portion of image around the object area OBA1 to generate a plurality of tracking images TGV each of which focuses on a different object area OBA1. Those tracking images TGV are displayed on the display of the note PC 12 at the same time, allowing a viewer to visually check a plurality of tracking images TGV showing a plurality of objects.

### (2-3) Tracking Process for a Plurality of Targets

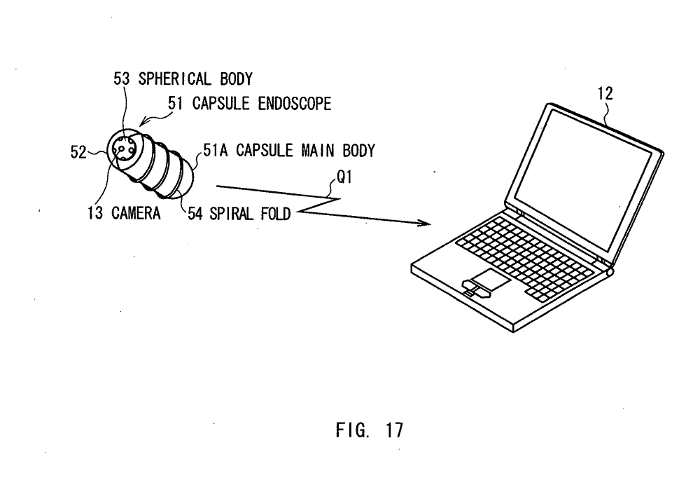

FIG. 16 is a flowchart illustrating a procedure of tracking process in which a plurality of targets are tracked and displayed in a case when a color of a plurality of objects has been specified by a viewer.

By the way, a procedure of tracking process for a plurality of targets when a pattern of a plurality of objects has been specified is different from the color-based process only in how to specify the object and uses the same technical concept. Accordingly, it won't be described for ease of explanation.

The image processing section 14 of the indoor situation confirmation ball 11 starts a routine RT2 from a start step and then proceeds to next step SP11. At step SP11, the image processing section 14 acquires from the image acquisition section 15 the image data group VG1 (or a plurality of images in different directions) captured by the n cameras 13A to 13n, and then proceeds to next step SP12.

At step SP12, the image processing section 14 removes, by using the background difference processing section 41 of the tracking section 20, background image to extract only the motion part data D1, and then proceeds to next step SP13.

At step SP13, the image processing section 14 extracts, by using the color extraction processing section 42, the object area OBA1 having the specified color information from the motion part data D1, based on the target identification signal TG1. The image processing section 14 subsequently proceeds to next step SP14.

At step SP14, if there is a plurality of objects areas OBA1 with the same color information, the image processing section 14 selects the biggest one in size. At subsequent step SP15, the image processing section 14 calculates the center-of-gravity point G1 of the biggest object area OBA1, and then proceeds to step SP16.

At step SP16, the image processing section 14 regards the center-of-gravity point G1 as the center of the object area OBA1 and then transforms the center-of-gravity point G1 into a three-dimensional coordinates on the spherical image Q1. The image processing section 14 subsequently proceeds to next step SP17.

At step SP17, the image processing section 14 checks if the process of step SP13 to SP16 has been done on all the other colors specified. If the negative result is obtained, the image processing section 14 returns to step SP13 and then recognizes the center-of-gravity points G1 of the object areas OBA1 of all the colors specified as a center of target, and keeps performing the process until all the center-of-gravity points G1 has been converted into three-dimensional coordinates on the spherical image Q1.

Whereas if the affirmative result is obtained at step SP17, this means that the center-of-gravity points of object areas OBA1 of all the colors specified have been already converted into three-dimensional coordinates on the spherical image Q1 after being recognized as centers of target. In this case, the image processing section 14 proceeds to next step SP18.

At step SP18, the image processing section 14 attaches those images of the image data group VG1 (a plurality of images in different directions), which was acquired at step SP11, to the surface of a spherical object to create the spherical image Q1 in which people can see all directions from its center. The image processing section 14 calculates the positional correlation between the spherical image Q1 and the object area OBA1 of each color, sets the object area OBA1 of each color around the center of the spherical image Q1, and then cuts off a part of the image such that it includes the object area OBA1 at its center. This generates the tracking image TGV that focuses on the object area OBA1, which is then wirelessly transmitted to the note PC 12 via the wireless communication interface 22. The image processing section 14 subsequently proceeds to next step SP19 to end the process.

### (2-4) Operation and Effect of the First Embodiment

In the above configuration of the indoor situation surveillance system 10 of the first embodiment, when the indoor situation confirmation ball 11 is thrown into a collapsed building at a disaster site, the n cameras 13A to 13n of the rolling indoor situation confirmation ball 11 take omnidirectional pictures (or a plurality of images in different directions). Based on those omnidirectional images, the indoor situation confirmation ball 11 generates the spherical image Q1. This provides a viewer with the spherical image Q1 on the note PC 12 as if he/she directly check the situation from inside the building, like rescue crew.

As the spherical body 11A of the indoor situation confirmation ball 11 rolls, the images captured by the n cameras 13A to 13n rotates around a reference frame. Accordingly, the rotation calculation section 18 of the image processing section 14 calculates the amount of rotation of the images around the reference frame to eliminate the effect of rotation between the reference frame and the subsequent frames. This produces the spherical image Q1, as if it was captured by one camera without shifting its position. The spherical image Q1 is displayed on the note PC 12.

That is, by displaying the spherical image Q1, the note PC 12 provides a viewer with moving images in real time, as if they were captured by one camera without shifting its position.

Moreover, the indoor situation surveillance system 10 tracks an object area OBA1 of each object specified as a target, calculates the positional correlation between the spherical image Q1 and each object area OBA1. Based on the positional correlation, the indoor situation surveillance system 10 sets the object area OBA1 such that its center-of-gravity point G1 is positioned around the center of the spherical image Q1 and then cuts off a part of the image that includes the object area OBA1 at its center. This produces the tracking image TGV of each color focusing on the object area OBA1. The tracking images TGV are wirelessly transmitted to the note PC 12 whose display then displays at the same time a plurality of objects tracked.

In that manner, in the indoor situation surveillance system 10, when the indoor situation confirmation ball 11 is for example thrown in the collapsed building at a disaster site, the indoor situation confirmation ball 11 tracks a plurality of objects a viewer specified and displays them on the note PC 12 as high-resolution images, which give him/her a sense of reality as if they are close to the object. If those objects are victims, the viewer can know their situation in detail.

In this case, the indoor situation surveillance system 10 emphasizes the object area OBA1 of the object the viewer operates on the display. Accordingly, the viewer can easily find out a target he/she is closely watching. This prevents the viewer from losing sight of the object during tracking display.

According to the above configuration of the indoor situation surveillance system 10, the indoor situation confirmation ball 11, which can move or roll in various manners, acquires a plurality of images in different directions and generates the spherical image Q1, which gives a sense of reality as if a viewer is at site. Out of the spherical image Q1, the indoor situation surveillance system 10 tracks his/her desired objects to be displayed in an eye-friendly format for the viewer.

### (3) Second Embodiment

### (3-1) Overall Configuration of Capsule Endoscope System of Second Embodiment

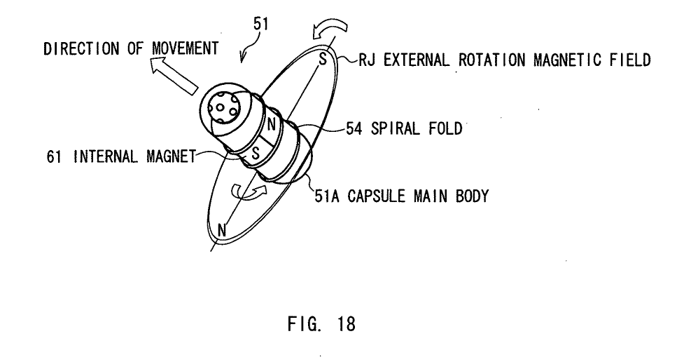

In FIG. 17 whose parts have been designated by the same reference numerals and symbols as the corresponding parts of FIG. 5, the reference numeral 50 denotes a capsule endoscope system according to a second embodiment of the present invention. The capsule endoscope system 50 includes a capsule endoscope 51, which is the equivalent of the object-surface-dispersed camera 1 (FIG. 1); and the note PC 12, which wirelessly receives and displays a spherical image Q1 generated by the capsule endoscope 51 that takes omnidirectional images (or a plurality of images in different directions) inside a person's body.

The capsule endoscope 51 includes the n cameras 13 placed on the surface of a spherical body 53 covered by a transparent cover 52 at the tip of the capsule. The cameras 13 are arranged to take omnidirectional images (or a plurality of images in different directions) inside a person's body. The positional correlations for connecting the images have been calibrated.

By the way, the capsule endoscope 51 does not have to acquire omnidirectional images: The capsule endoscope 51 should acquire at least a predetermined number of images in different directions so that it can generate the spherical image Q1. In addition, the optical axes of the n cameras 13 may not be aligned with lines that extend from the center of the spherical body 53 in a radial pattern.

The capsule endoscope system 50 is designed to allow a person to swallow the capsule endoscope 51 and monitor the situation inside the body, such as stomach or digestive organs, in real time on the display of the note PC 12 by taking pictures through the n cameras 13.

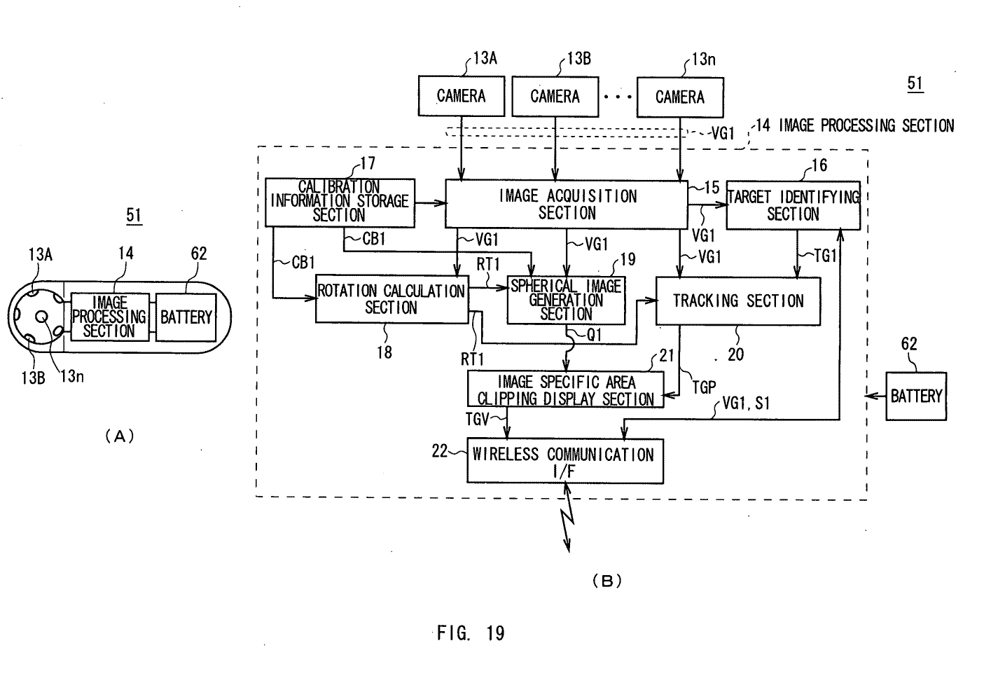

As shown in FIG. 18, the capsule endoscope system 50 includes an outside-body magnetic field generator (not shown) in which opposed-type electromagnets that can produce magnetic fields at a constant level are arranged in three directions or (X, Y, Z). This produces magnetic fields (Positive/Negative) in certain directions, orienting the capsule endoscope 51 in a certain direction through an internal magnet 61 of a capsule main body 51A of the capsule endoscope 51. The magnetic field of this direction generates an external rotation magnetic field RJ, rotating the capsule main body 51A. This gives the capsule endoscope 51 the power to go forward through a spiral fold 54 around the surface of the capsule main body 51A.

In this manner, the capsule endoscope system 50 can control the movement and direction of the capsule endoscope 51. This allows the capsule endoscope 51 to approach a particular part of a body. In addition, the capsule endoscope 51 can adjust its direction and position in order to observe inside a body.

### (3-2) Circuit Configuration of Capsule Endoscope

As shown in FIGS. 19(A) and (B), whose parts have been designated by the same reference numerals and symbols as the corresponding parts of FIG. 6, the capsule endoscope 51 includes inside the capsule main body 51 a small battery 62, which supplies power to an image processing section 14. The image processing section 14 has the same circuit configuration as that of the indoor situation confirmation ball 11 of the first embodiment.

The capsule endoscope 51 inputs an image data group VG1 (a plurality of images in different directions) acquired from the n cameras 13A to 13n into an image acquisition section 15 of an image processing section 14. The image data group VG1 is supplied from the image acquisition section 15 to a target identifying section 16, a rotation calculation section 18, a spherical image generation section 19 and a tracking section 20.

The image processing section 14 includes a calibration information storage section 17 that supplies calibration information CB1 to the rotation calculation section 18 and the spherical image generation section 19.

The target identifying section 16 wirelessly transmits the image data group VG1 supplied from the image acquisition section 15 to the note PC 12 via a wireless communication interface 22.

The note PC 12 wirelessly receives from the capsule endoscope 51 the image data group VG1 and displays an image of the situation inside the body, which corresponds to the image data group VG1, on a display. The note PC 12 allows a viewer to specify his/her desired part of the body from the image through a mouse or the like and generates a specification signal S1 that indicates that part, which is then wirelessly transmitted to the capsule endoscope 51.

The image processing section 14 of the capsule endoscope 51 wirelessly receives from the note PC 12 via the wireless communication interface 22 the specification signal S1, which is then supplied to the target identifying section 16.

Based on the specification signal S1 supplied from the note PC 12, the target identifying section 16 identifies, from the image data group VG1 supplied from the image acquisition section 15, the body's part as a target based on a color or pattern specified by the viewer. The target identifying section 16 transmits a target identification signal TG1 that indicates the identified target to the tracking section 20.

On the other hand, the rotation calculation section 18 of the capsule endoscope 51 sequentially calculates how much, with reference to a reference image frame, the next frame has rotated when the capsule endoscope 51 moves or rotates, by using the calibration information CB1 supplied from the calibration information storage section 17 and the image data group VG1 supplied from the image acquisition section 15.

By the way, the calibration information CB1 is used to produce the spherical image Q1. The calibration information CB1 includes geometric information to calibrate lens distortion of each camera 13A to 13n and information that represents connection-positional correlation for connecting omnidirectional images captured inside the body by the n cameras 13A to 13n on the surface of the spherical body 11A. The image processing section 14 uses the calibration information CB1 to seamlessly connect those omnidirectional images captured by the cameras 13A to 13n. This produces the spherical image Q1 without distortion.

The calibration information storage section 17 has recognized the connection-positional correlation, which is used for connecting a plurality of images of different directions from the n cameras 13A to 13n, as the calibration information CB1. The calibration information CB1 can be calibrated later by a viewer. Especially, the images taken by the n cameras 13A to 13n are partially overlapped with one another. Those images are seamlessly connected based on the calibration information CB1, generating a connection image or the spherical image Q1.

Actually, the rotation calculation section 18 inputs each image of the image data group VG1 supplied from the image acquisition section 15 into a image conversion section 31, as shown in FIG. 7. The image conversion section 31 converts the images of the image data group VG1 into 1024×768-pixel RGB signals and then into 512×384-pixel brightness signals Y, which are then transmitted to a template determination section 32.

The reason why the image conversion section 31 converts the RGB signals into the brightness signals Y is that using RGB signals for calculating rotation takes much more calculation time, and therefore the conversion can reduce calculation time. On the other hand, the RGB signals are stored separately.

As shown in FIG. 8, the template determination section 32 uses the brightness signals Y to check 16×16-pixel templates TP of the previous frame in order to determine whether they are appropriate for pattern matching: There are 25 templates in this case.

Pattern matching is performed by searching a minimum value of SAD based on the proper template TP1 of the previous frame as shown in FIG. 11 and detecting the position of a template TP2 corresponding to the template TP1 from the latest frame following the previous frame, or how far the template TP1 or TP2 has moved. This search has two stages, one for roughly searching by 4-pixel unit and the other for carefully searching by one-pixel unit, in order to speed up pattern matching.

In this manner, the template determination section 32 selects the templates TP1 and TP2 appropriate for pattern matching from the 25 templates TP1 and TP2, and then transmits template information T1 that indicates the selected templates TP1 and TP2 to a pattern matching section 33. By the way, the template determination section 32 at the time stores the template information T1 for the next frame.

The pattern matching section 33 only uses the appropriate templates TP1 and TP2 in accordance with the template information T1 supplied from the template determination section 32, and detects, by pattern matching, how far the previous frame's template TP1 or the latest frame's template TP2 has moved, as a travel distance. The detected result S2 is transmitted to a coordinate conversion section 34.

The coordinate conversion section 34 recognizes, based on the calibration information CB1 from the calibration information storage section 17, the connection-positional correlation for generating the spherical image Q1 as three-dimensional coordinates. The coordinate conversion section 34 converts the position of the previous frame's template TP1 into a three-dimensional coordinates (x, y, z) of the spherical image Q1 and the position of the latest frame's template TP2 (which is equal to “the position of the previous frame”+“the travel distance”) into a three-dimensional coordinates (x′, y′, z′) of the spherical image Q1. The previous frame's three-dimensional coordinates (x, y, z) and the latest frame's three-dimensional coordinates (x′, y′, z′) are transmitted to a rotation estimation section 35.

The rotation estimation section 35 for example assumes that the spherical image Q1 is a 2.5 meter radius ball on which a plurality of images acquired from the n cameras 13A to 13n are mapped. The rotation estimation section 35 calculates how the templates TP1 and TP2 have moved on the surface of the spherical image Q1 by using the above formulas (1) to (3) and then transmits the resultant rotation information RT1 to the spherical image generation section 19 and the tracking section 20.

By the way, when calculating the amount of rotation of the latest frame, the rotation calculation section 18 needs to calculate not only the amount of rotation from the previous frame but also the total amount of rotation accumulated from the reference frame.

Since such a rotation calculation process by the rotation calculation section 18 with optical flow was described in FIG. 12, it won't be described here.

The spherical image generation section 19 generates the spherical image Q1 by connecting the image data group's images captured by the n cameras, based on the image data group VG1 supplied from the image acquisition section 15, the calibration information CB1 supplied from the calibration information storage section 17 and the rotation information RT1 supplied from the rotation calculation section 18. The spherical image generation section 19 subsequently supplies the spherical image Q1 to an image specific area clipping display section 21.

The tracking section 20 identifies the viewer's desired body part from each image of the image data group VG1 for tracking display, based on the image data group VG1 supplied from the image acquisition section 15 and the target identification signal TG1 supplied from the target identifying section 16. The tracking section 20 subsequently transmits target position information TGP that indicates the target to the image specific area clipping display section 21.

To generate the target position information TGP, the tracking section 20 has different sets of circuit configuration for processing the target identification signal TG1 that specifies a color and the target identification signal TG1 that specifies a pattern: The target identification signals TG1 are supplied from the target identifying section 16. Since those circuit configurations were described in FIGS. 13 and 15, it won't be described here.

The emphasizing display section 44 of the tracking section 20 (FIG. 13) recognizes the object area OBA1 (FIG. 14), which corresponds to the specified body part, from the target position information TGP, and performs an emphasizing display process (at least one of the following processes: a color-tone process, an edge enhancement process, and a contrasting process) to emphasize the object to be tracked. This allows a viewer to recognize it easily. The emphasizing display section 44 transmits the target position information TGP to the image specific area clipping display section 21.

The image specific area clipping display section 21 calculates a positional correlation between the spherical image Q1 generated by the spherical image generation section 19 and the object area OBA1 for which the tracking section 20 has performed an emphasizing display process by using the target position information TGP. Based on the positional correlation, the image specific area clipping display section 21 sets an image area corresponding to the object area OBA1 and places it such that the object area OBA1 is positioned around the center of the spherical image Q1 and then clips a portion of image around the object area OBA1 to generate a tracking image TGV that focuses on the object area OBA1. The image specific area clipping display section 21 then wirelessly transmits the tracking image TGV to the note PC 12 via the wireless communication interface 22.

By the way, if an object is not specified by a viewer, the image specific area clipping display section 21 wirelessly transmits the spherical image Q1 supplied from the spherical image generation section 19 to the note PC 12 via the wireless communication interface 22.

If there is a plurality of objects or body parts specified by a viewer, the note PC 12 generates each object's tracking image TGV and displays them on a display at the same time, allowing a viewer to visually check a plurality of tracking images TVG for a plurality of body parts at the same time.

By the way, the image processing section 14 can wirelessly transmit the spherical image Q1 to the note PC 12 via the wireless communication interface 22. This allows a viewer to specify his/her desired body parts from the spherical image Q1 on a display of the note PC 12.

The note PC 12 holds identification information of the cameras 13A to 13n that output a plurality of images in different directions, which constitute the spherical image Q1. When ordered by a viewer, the note PC 12 temporarily holds the spherical image Q1 in the form of a still image. When a viewer specifies his/her desired body part from the still image or the spherical image Q1, the note PC 12 wirelessly transmits a resulting specification signal S1 and the identification information to the capsule endoscope 51.

After receiving the specification signal S1 and the identification information via the wireless communication interface 22, the image processing section 14 of the capsule endoscope 51 identifies one of the cameras 13A to 13n outputting an image including the object area OBA1 of the body part the specification signal S1 has specified, based on the identification information, by using the image specific area clipping display section 21.

By using the cameras 13A to 13n identified by the identification information, the image specific area clipping display section 21 counts how many frames there are between the temporarily-held stationary spherical image Q1 and another spherical image received at the time when the specification signal S1 was received to recognize how it has moved over time. In this manner, the image specific area clipping display section 21 figures out the current position of the object area OBA1, which was specified by the specification signal S1, on the spherical image Q1.

Subsequently, the image specific area clipping display section 21 recognizes the current position of the object area OBA1 on the spherical image Q1, and then sets an image area corresponding to the object area OBA1 located at that position. The image specific area clipping display section 21 then clips out a portion of image, in which the object area OBA1 is positioned around the center of the spherical image Q1, in order to generate the tracking image TGV that focuses on the object area OBA1. The image specific area clipping display section 21 wirelessly transmits the tracking image TGV to the note PC 12 via the wireless communication interface 22.

In that manner, the note PC 12 displays on a display the tracking image TGV that tracks, as a target, the object area OBA1 of the body part that was specified on the stationary spherical image Q1. This allows a viewer to visually check the body part in real time.

If there is a plurality of body parts specified, the image processing section 14 of the capsule endoscope 51 calculates positional correlations between a plurality of object areas OBA1 and the spherical image Q1. Based on the positional correlations, the image processing section 14 places the object areas OBA1 such that each object area OBA1 is positioned around the center of the spherical image Q1 and then clips a portion of image around the object area OBA1 to generate a plurality of tracking images TGV each of which focuses on a different object area OBA1. Those tracking images TGV are displayed on the display of the note PC 12 at the same time, allowing a viewer to visually check a plurality of tracking images TGV showing a plurality of body parts.

By the way, a procedure of tracking process for a plurality of targets when a color of a plurality of body parts has been specified by a viewer is substantially the same as that of FIG. 16. Accordingly, it won't be described here.

### (3-3) Operation and Effect of the Second Embodiment

In the above configuration of the capsule endoscope system 50 of the second embodiment, when the capsule endoscope 51 gets inside a person's body, the n cameras 13A to 13n take omnidirectional pictures while the capsule endoscope 51 is rolling inside a human body. Based on those omnidirectional images, the capsule endoscope 51 generates the spherical image Q1. This provides a viewer with the spherical image Q1 on the note PC 12 as if he/she directly checks the situation from inside the body.

As the capsule main body 51A of the capsule endoscope 51 rolls, the images captured by the n cameras 13A to 13n rotate around a reference frame. Accordingly, the rotation calculation section 18 of the image processing section 14 calculates the amount of rotation of the images around the reference frame to eliminate the effect of rotation between the reference frame and the subsequent frames. This produces the spherical image Q1, as if it was captured by one camera without shifting its position. The spherical image Q1 is displayed on the note PC 12.

That is, by displaying the spherical image Q1, the note PC 12 provides a viewer with moving images in real time, as if they were captured inside a human body by one camera without shifting its position.

Moreover, the capsule endoscope system 50 tracks an object area OBA1 of each body part specified as a target, calculates the positional correlation between the spherical image Q1 and each object area OBA1. Based on the positional correlation, the capsule endoscope system 50 sets the object area OBA1 such that its center-of-gravity point G1 is positioned around the center of the spherical image Q1 and then cuts off a part of the image that includes the object area OBA1 at its center. This produces the tracking image TGV of each color (or each body part), focusing on the object area OBA1. The tracking images TGV are wirelessly transmitted to the note PC 12 whose display then displays at the same time a plurality of body parts tracked.

In this manner, the capsule endoscope system 50 can track a particular part inside a human body and can display high-resolution images, which gives him/her a sense of reality as if they were captured near the part. If that part is an area affected by diseases, the viewer can know the situation in detail.

In this case, the capsule endoscope system 50 emphasizes on the display the object area OBA1 of the body part the viewer focuses on. Accordingly, the viewer can easily find out a target he/she is closely watching. This prevents the viewer from losing sight of the target during tracking display.

According to the above configuration of the capsule endoscope system 50, the capsule endoscope 51, which can move or roll in various manners inside a human body, acquires omnidirectional images and generates the spherical image Q1. Out of the spherical image Q1, the capsule endoscope system 50 tracks the body parts a viewer focuses on and presents them in an eye-friendly format for the viewer.

### (4) Third Embodiment

### (4-1) Overall Configuration of Security System of Third Embodiment

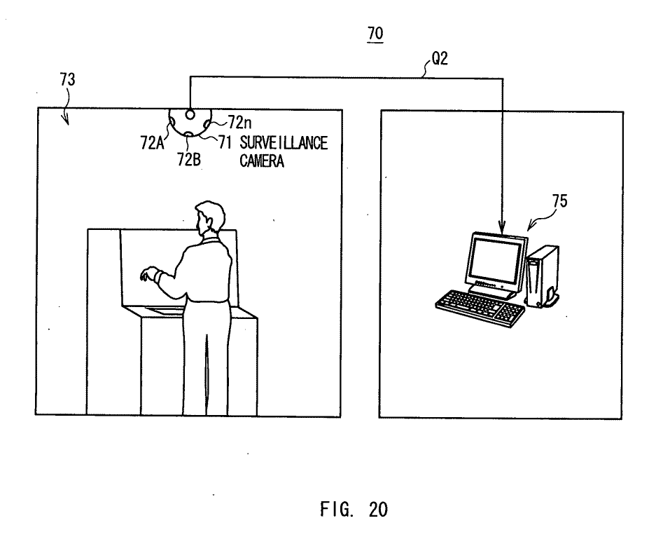

In FIG. 20 whose parts have been designated by the same reference numerals and symbols as the corresponding parts of FIG. 5, the reference numeral 70 denotes a security system according to a third embodiment of the present invention. The security system 70 includes a surveillance camera 71, which is the equivalent of the object-surface-dispersed camera 1 (FIG. 1) and is attached to a ceiling; and a personal computer 75, which wirelessly receives a hemispherical image Q2 from the surveillance camera 71 that includes the n cameras 72A to 72n on its hemispherical body. The n cameras 72A to 72n for example take omnidirectional images inside an ATM room 73 at a bank and combine them to generate the hemispherical image Q2.

The surveillance camera 71 includes the n cameras 72A to 72n placed on the surface of the hemispherical body. The cameras 72A to 72n are arranged and calibrated to take omnidirectional images (or a plurality of images in different directions) inside the ATM room 73.

By the way, the surveillance camera 71 does not have to acquire omnidirectional images: The surveillance camera 71 should acquire at least a predetermined number of images in different directions so that it can generate the hemispherical image Q2. In addition, the optical axes of the n cameras 72A to 72n may not be aligned with lines that extend from the center of the hemispherical body in a radial pattern.

By the way, the surveillance camera 71 does not rotate and the cameras 71A to 71n are fixed on the surface of the hemispherical body. The number of cameras 71A to 71n and the arrangement of the cameras 71A to 71n have been calibrated in order to acquire omnidirectional images (a plurality of images in different directions) inside the ATM room 73 within a range of 180 degrees.

In this security system 70, while the surveillance camera 71 has been installed in the ATM room 73, a personal computer 75 is in a separate room. Accordingly, a monitor of the personal computer 75 displays the situation inside the ATM room 73 in real time.

By the way, in the security system 70, the surveillance cameras 71 may be installed not only in the ATM room 73 but also at the front of the bank to monitor a street in front of the bank. In this case, the monitor of the personal computer 75 displays passengers walking on the street or the like in real time.

### (4-2) Circuit Configuration of Security System

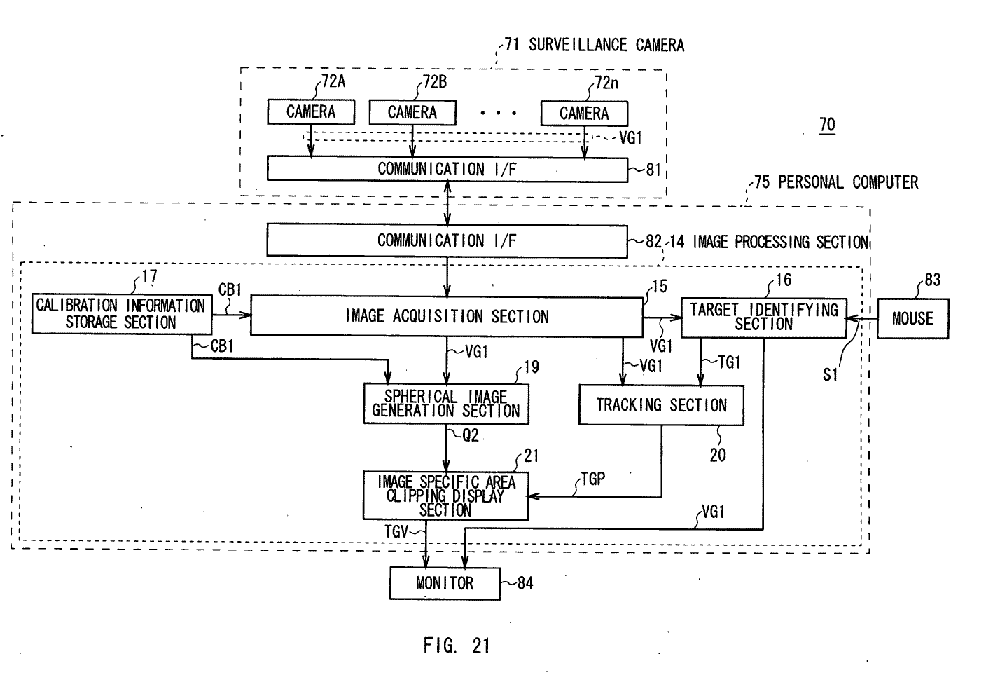

As shown in FIG. 21, whose parts have been designated by the same reference numerals and symbols as the corresponding parts of FIG. 6, in the security system 70, the surveillance camera 71 and the personal computer 75 are connected by a wire via their communication interfaces 81 and 82.

The surveillance camera 71 transmits an image data group VG1 (a plurality of images in different directions) acquired from the n cameras 72A to 72n on the hemispherical body to the personal computer 75 via the communication interface 81.

The personal computer 75 receives the image data group VG1 from the surveillance camera 71 via the communication interface 82 and inputs it into an image acquisition section 15 of an image processing section 14. The image data group VG1 is supplied from the image acquisition section 15 to a target identifying section 16, a spherical image generation section 19, and a tracking section 20.

The image processing section 14 of the personal computer 75 includes a calibration information storage section 17 that supplies calibration information CB1 to the spherical image generation section 19.

The target identifying section 16 transmits the image data group VG1 supplied from the image acquisition section 15 to the monitor 84, which then displays a plurality of images of different directions captured by the surveillance camera 71. The target identifying section 16 allows a viewer to specify a certain area of the ATM room 73 from the image through a mouse 83 and generates a target identification signal TG1 that indicates that area, which is then transmitted to the tracking section 20.

By the way, the calibration information CB1 is used to produce the hemispherical image Q2. The calibration information CB1 includes geometric information to calibrate lens distortion of each camera 72A to 72n and information that represents connection-positional correlation for connecting omnidirectional images captured by the n cameras 72A to 72n on the surface of the hemispherical body. The image processing section 14 uses the calibration information CB1 to seamlessly connect those omnidirectional images captured by the n cameras 72A to 72n. This produces the hemispherical image Q2 without distortion.

The calibration information storage section 17 has recognized the connection-positional correlation, which is used for connecting a plurality of images of different directions from the n cameras 72A to 72n, as the calibration information CB1. The calibration information CB1 can be calibrated later by a viewer. Especially, the images taken by the n cameras 72A to 72n are partially overlapped with one another. Those images are seamlessly connected based on the calibration information CB1, generating a connection image or the hemispherical image Q2.

The spherical image generation section 19 generates the hemispherical image Q2 by connecting the image data group VG1's images captured by the n cameras 72A to 72n, based on the image data group VG1 supplied from the image acquisition section 15 and the calibration information CB1 supplied from the calibration information storage section 17. The spherical image generation section 19 subsequently supplies the hemispherical image Q2 to an image specific area clipping display section 21.

The tracking section 20 identifies the particular area of the ATM room 73, which the viewer wants to observe, from each image of the image data group VG1 for tracking display, based on the image data group VG1 supplied from the image acquisition section 15 and the target identification signal TG1 supplied from the target identifying section 16. The tracking section 20 subsequently transmits target position information TGP that indicates the area to the image specific area clipping display section 21.

To generate the target position information TGP, the tracking section 20 has different sets of circuit configuration for processing the target identification signal TG1 that specifies a color and the target identification signal TG1 that specifies a pattern: The target identification signals TG1 are supplied from the target identifying section 16. Since those circuit configurations were described in FIGS. 13 and 15, it won't be described here.

By the way, since the tracking section 20 of the third embodiment does not use the rotation information RT1, the process can be simplified.

The emphasizing display section 44 of the tracking section 20 (FIG. 13) recognizes the object area OBA1, which corresponds to the particular area of the ATM room 73, from the target position information TGP, and performs an emphasizing display process (at least one of the following processes: a color-tone process, an edge enhancement process, and a contrasting process) to emphasize the area as the target of tracking. This allows a viewer to recognize it easily. The emphasizing display section 44 transmits the target position information TGP to the image specific area clipping display section 21.

The image specific area clipping display section 21 calculates a positional correlation between the hemispherical image Q2 generated by the spherical image generation section 19 and the object area OBA1 for which the tracking section 20 has performed an emphasizing display process by using the target position information TGP. Based on the positional correlation, the image specific area clipping display section 21 sets an image area corresponding to the object area OBA1 and places it such that the object area OBA1 is positioned around the center of the hemispherical image Q2 and then clips a portion of image around the object area OBA1 to generate a tracking image TGV that focuses on the emphasized object area OBA1. The image specific area clipping display section 21 then transmits the tracking image TGV to the monitor 84.

By the way, if an area inside the ATM room 73 is not specified by a viewer, the image specific area clipping display section 21 transmits the hemispherical image Q2 supplied from the spherical image generation section 19 to the monitor 84.

If there is a plurality of areas specified by a viewer, the personal computer 75 generates each area's tracking image TGV and displays them on the monitor 84 at the same time, allowing a viewer to visually check a plurality of tracking images TVG for a plurality of areas at the same time.

By the way, the image processing section 14 of the personal computer 75 allows a viewer to specify his/her desired areas of the ATM room 73 from the hemispherical image Q2 displayed on the monitor 84.

The personal computer 75 holds identification information of the cameras 72A to 72n that output a plurality of images of different directions, which constitute the hemispherical image Q2. When ordered by a viewer, the personal computer 75 temporarily holds the hemispherical image Q2 in the form of a still image. When a viewer specifies an area of the ATM room 73 from the still image or the hemispherical image Q2 by using the mouse 83, the personal computer 75 transmits a resulting specification signal S1 and the identification information to the target identifying section 16.

Accordingly, the image processing section 14 of the personal computer 75 outputs the target position information TGP indicating the area specified by the viewer via the target identifying section 16 and the tracking section 20 to the image specific area clipping display section 21.

The image specific area clipping display section 21 identifies one of the cameras 13A to 13n outputting an image including the object area OBA1 of an area specified by the target position information TGP, based on the identification information.

By using the camera 13A to 13n identified by the identification information, the image specific area clipping display section 21 counts how many frames there are between the temporarily-held stationary hemispherical image Q2 and another hemispherical image Q2 received at the time when the area inside the ATM room 73 was specified by the mouse 83 to recognize how it has moved over time. In this manner, the image specific area clipping display section 21 figures out the current position of the object area OBA1, which was specified by the mouse 83, on the hemispherical image Q2.

Subsequently, the image specific area clipping display section 21 recognizes the current position of the object area OBA1 on the hemispherical image Q2, and then sets an image area, which corresponds to the object area OBA1 located at that position, on the hemispherical image Q2. The image specific area clipping display section 21 then clips out a portion of image, in which the object area OBA1 is positioned around the center of the hemispherical image Q2, in order to generate the tracking image TGV that focuses on the object area OBA1. The image specific area clipping display section 21 transmits the tracking image TGV to the monitor 84.

In that manner, the personal computer 75 displays on the monitor 84 the tracking image TGV that tracks, as a target, the object area OBA1 of the ATM room 73's area that was specified on the hemispherical image Q2. This allows a viewer to visually check the area in real time.

If there is a plurality of areas specified, the image processing section 14 of the personal computer 75 calculates positional correlations between a plurality of object areas OBA1 and the hemispherical image Q2. Based on the positional correlations, the image processing section 14 places the object areas OBA1 such that each object area OBA1 is positioned around the center of the hemispherical image Q2 and then clips a portion of image around the object area OBA1 to generate a plurality of tracking images TGV each of which focuses on a different object area OBA1. Those tracking images TGV are displayed on the monitor 84 at the same time, allowing a viewer to visually check a plurality of tracking images TGV showing a plurality of areas specified inside the ATM room 73.

By the way, a procedure of tracking process for a plurality of targets when a color of a plurality of areas inside the ATM room 73 has been specified is substantially the same as that of FIG. 16. Accordingly, it won't be described here.

### (4-3) Operation and Effect of the Third Embodiment

In the above configuration of the security system 70 of the third embodiment, the n cameras 72A to 72n of the surveillance camera 71 attached to the ceiling of the ATM room 73 take omnidirectional pictures inside the ATM room 73. Based on those omnidirectional images, the security system 70 generates the hemispherical image Q2. This provides a viewer with the hemispherical image Q2 as if he/she is directly checking the situation inside the ATM room 73.

Moreover, the security system 70 tracks an object area OBA1 of each ATM room's area specified as a target, calculates the positional correlation between the hemispherical image Q2 and each object area OBA1. Based on the positional correlation, the security system 70 sets the object area OBA1 such that its center-of-gravity point G1 is positioned around the center of the hemispherical image Q2 and then cuts off a part of the image that includes the object area OBA1 at its center. This produces the tracking image TGV of each specified area, which focuses on the object area OBA1. The tracking images TGV are transmitted to the monitor 84, which then displays at the same time a plurality of areas tracked.

In that manner, the security system 70 can track the specified area inside the ATM room 73 and display high-resolution images, which give him/her a sense of reality as if they were captured near the area. If there are wrongdoers in that area, the viewer can visually check them in detail.

In this case, the security system 70 emphasizes on the monitor the object area OBA1 of the area the viewer focuses on. Accordingly, the viewer can easily find out a target he/she is closely watching. This prevents the viewer from losing sight of the target during tracking display.

According to the above configuration of the security system 70, the surveillance camera 71 acquires omnidirectional images and generates the hemispherical image Q2 of the ATM room 73. Out of the hemispherical image Q2, the surveillance camera 71 tracks the areas the viewer focuses on and presents them in an eye-friendly format for the viewer.

### (5) Other Embodiment

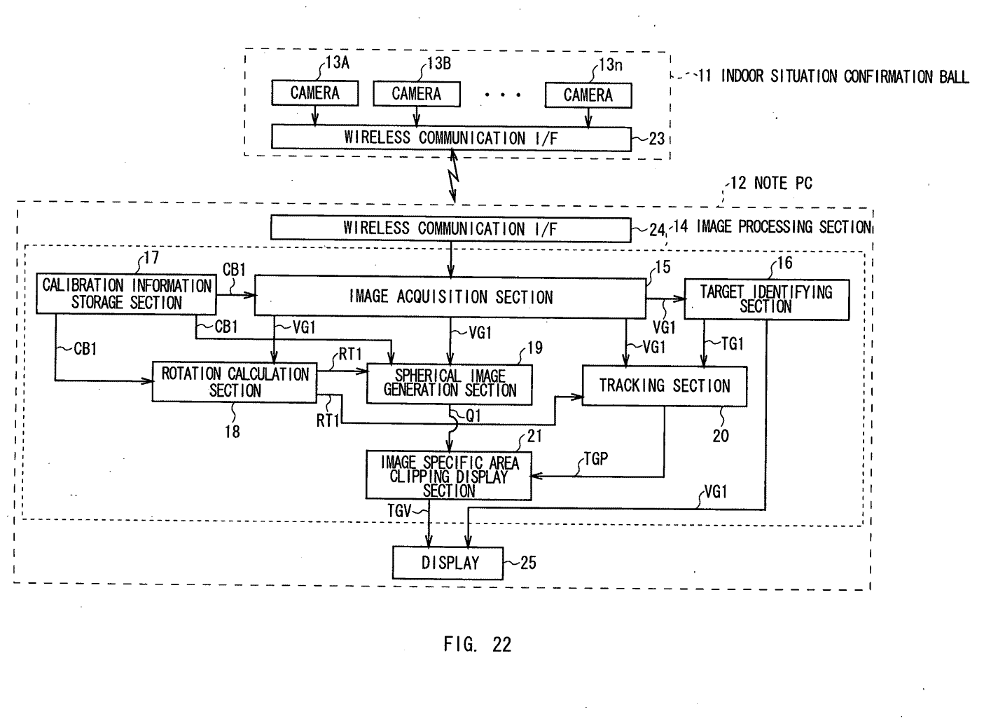

In the above-noted first embodiment, the image processing section 14 has been installed inside the indoor situation confirmation ball 11 (FIG. 6). The image processing section 14 generates the spherical image Q1, which is then wirelessly transmitted to the note PC 12. The note PC 12 displays the spherical image Q1. However, the present invention is not limited to this. For example, as shown in FIG. 22, instead of the image processing section 14 installed inside the indoor situation confirmation ball 11, the indoor situation confirmation ball 11 may only include the n cameras 13A to 13n and the wireless communication interface 23 that wirelessly transmits the image data group VG (a plurality of images of different directions) to the note PC 12, while the note PC 12 may include the image processing section 14 and the wireless communication interface 24 that receives the image data group VG1 from the indoor situation confirmation ball 11. Even in this case, the note PC 12 can display on the display 25 the spherical image Q1 generated by the image processing section 14.

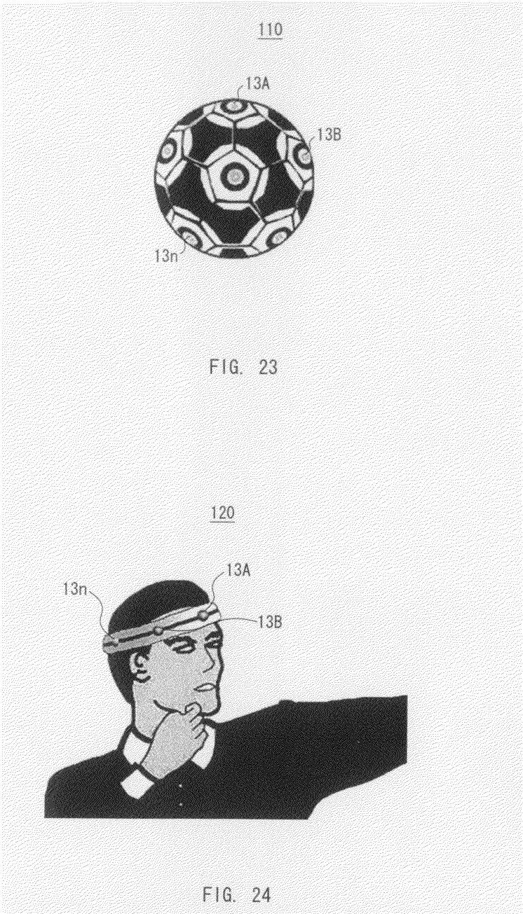

Moreover, in the above-noted first embodiment, the indoor situation surveillance system 10 includes the indoor situation confirmation ball 11, which is the equivalent of the object-surface-dispersed camera 1 (FIG. 1). However, the present invention is not limited to this. The following devices can be used in the same way as the object-surface-dispersed camera 1 (FIG. 1) to build a sports watching system: a camera-attached soccer ball 110 with the n cameras 13A to 13n on its surface, as shown in FIG. 23; a camera-attached basketball (not shown); a camera-attached headband 120 with the n cameras 13A to 13n around the head of a referee, as shown in FIG. 24; or a camera-attached cap (not shown) with the cameras attached on its side and top.

Furthermore, in the above-noted second embodiment, the capsule endoscope 51 (FIG. 19) of the capsule endoscope system 50 is powered by the battery 62 to operate the image processing section 14. However, the present invention is not limited to this. Alternatively, the capsule endoscope 51 may be powered by a power receiving coil (not shown) in the capsule main body 51A, which works according to the principle of electromagnetic induction by using a magnetic field generated by a coil outside a human body.

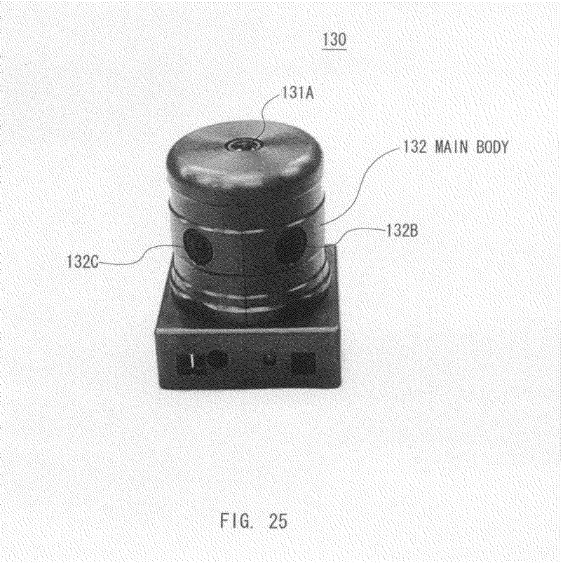

Furthermore, in the above-noted first to third embodiments, the n cameras 13A to 13n or 71A to 72n are attached to the surface of a spherical body. However, the present invention is not limited to this. Alternatively, the cameras may be placed on the faces of a cube, for example, which is provided inside a transparent acrylic spherical object; the faces of a polyhedral object other than a cube; or the same plane. A place where the cameras are provided, the arrangement of cameras and the number of cameras may vary. For example, as shown in FIG. 25, a camera 131A can be provided on the top of a cylindrical main body 132 of an object-surface-dispersed camera 130, and a plurality of cameras 132B and 132C on its side.

That is, as long as the images captured by those cameras are partially overlapped with one another so that they can be seamlessly combined into the spherical image Q1 or the hemispherical image Q2, the shape of an object on which the cameras are arranged, the arrangement of cameras and the number of cameras can vary.

Furthermore, in the above-noted first to third embodiments, a viewer can specify his/her desired object, place or area from the stationary spherical or hemispherical image Q1 or Q2 for tracking display. However, the present invention is not limited to this. A viewer may be able to specify his/her desired object, place or area from the moving spherical or hemispherical image Q1 or Q2 for tracking display.

Furthermore, in the above-noted first embodiment, the indoor situation confirmation ball 11, whose n cameras 13A to 13n take omnidirectional images, is designed to roll. However, the present invention is not limited to this. The indoor situation confirmation ball 11 may be equipped with a rotation motor inside, in order to automatically roll when taking omnidirectional pictures.

Furthermore, in the above-noted second embodiment, the image processing section 14 is placed inside the capsule endoscope 51 and the capsule endoscope 51 wirelessly transmits the spherical image Q1 and the tracking image TGV to the note PC 12. However, the present invention is not limited to this. Alternatively, the image processing section 14 may be placed inside the note PC 12 instead of the capsule endoscope 51: The capsule endoscope 51 wirelessly transmits omnidirectional images to the note PC 12 whose image processing section 14 then generates the spherical image Q1 and the tracking image TGV.

Furthermore, in the above-noted third embodiment, the n cameras 72A to 72n are fixed on the surface of the hemispherical body of the surveillance camera 71. However, the present invention is not limited to this. Alternatively, the n cameras 72A to 72n may be attached to the surface of the hemispherical body in a way that allows the cameras 72A to 72n to freely move on the surface for calibration.

Furthermore, in the above-noted third embodiment, the cameras 72A to 72n are provided on the surveillance camera 71 while the personal computer 75 is equipped with the image processing section 14. However, the present invention is not limited to this. Alternatively, the surveillance camera 71 may be equipped with the cameras 72A to 72n and the image processing section 14 and transmit the generated hemispherical image Q2 and tracking image TGV to the personal computer 75.

Furthermore, in the above-noted third embodiment, the hemispherical surveillance camera 71 is fixed on the ceiling of the ATM room 73. However, the present invention is not limited to this. Alternatively, the spherical surveillance camera may dangle from the ceiling so that it can rotate to take omnidirectional images inside the ATM room 73. In this case, its image processing section 14 may be equipped with the rotation calculation section 18, which is also used in the first and second embodiments: The rotation calculation section 18 supplies the rotation information RT1 to the spherical image generation section 19 and the tracking section 20.

Furthermore, in the above-noted first to third embodiments, the taken-image processing device of the present invention is applied to the indoor situation surveillance system 10, the capsule endoscope system 50 and the security system 70. However, the present invention is not limited to this. The taken-image processing device may be also applied to other systems.

Furthermore, in the above-noted first to second embodiments, the spherical image Q1 generated is a perfect spherical shape. However, the present invention is not limited to this. The spherical image may lack part of its spherical body, or may have the shape of a rugby ball.

Furthermore, in the above-noted embodiments, the indoor situation surveillance system 10, the capsule endoscope system 50 and the security system 70, as the taken-image processing devices, are equipped with a plurality of image pickup elements or the cameras 13A to 13n or 72A to 72n; an image connection means or the spherical image generation section 19; a target specification means or the target identifying section 16; and a image processing means or the image specific area clipping display section 21. However, the present invention is not limited to this. The taken-image processing devices may be configured in various ways such that they include a plurality of image pickup elements, the image connection means, the target specification means and the image processing means.

### INDUSTRIAL APPLICABILITY

The interactive image acquisition device of the present invention can be applied to various imaging systems that closely track an object, take its images, and then present them in a way that gives a sense of reality, for example.

1. An interactive image acquisition device comprising:
a plurality of image pickup elements that can move in a space and are arranged so as to take images of different directions such that the images captured by at least two or more image pickup elements are partially overlapped with one another;
image connection means for connecting the images captured by the image pickup elements;
target specification means for specifying a desired target object from the image captured by the image pickup elements; and
image processing means for calculating a positional correlation between a connection image that the image connection means produced by connecting the images and the target object specified by the target specification means and arranging the target object substantially at the center of the connection image in accordance with the positional correlation.

2. The interactive image acquisition device according to claim 1, comprising calibration means for previously recognizing and calibrating a connection-positional correlation of the images captured by the image pickup elements.

3. The interactive image acquisition device according to claim 1, comprising specification target emphasizing means for emphasizing the fact that the target object was specified, for the target object specified by the target specification means.

4. The interactive image acquisition device according to claim 1, comprising:
wireless transmission means for wirelessly transmitting the images captured by the image pickup elements; and
image receiving means for receiving the images wirelessly transmitted from the wireless transmission means, wherein
the images received by the image receiving means are supplied to the image connection means.

5. The interactive image acquisition device according to claim 1, comprising:
temporary storage means for temporarily storing the connection image connected by the image connection means in the form of a still image;
identification information storage means for storing identification information of the image pickup elements that output the images constituting the connection image; and
current arrangement calculation means for tracking, when the target object is specified by the target specification means from the connection image read out from the temporary storage means, how the temporarily-stored connection image and the connection image currently acquired from the image pickup elements corresponding to the identification information move over time in order to calculate the current arrangement of the specified target object, wherein
the target object is specified by the target specification means from the connection image that the temporary storage means temporarily stores in the form of a still image and the image processing means calculates the positional correlation of the current images in accordance with the current arrangement.

6. An interactive image acquisition device comprising:
a plurality of image pickup elements that can move in a space and are arranged so as to take images of different directions such that the images captured by at least two or more image pickup elements are partially overlapped with one another;
image connection means for connecting the images captured by the image pickup elements;
target specification means for specifying a desired target object from the image captured by the image pickup elements;
power supply means for supplying driving electric power to the image pickup elements; and
image processing means for calculating a positional correlation between a connection image that the image connection means produced by connecting the images and the target object specified by the target specification means and arranging the target object substantially at the center of the connection image in accordance with the positional correlation.

7. The interactive image acquisition device according to claim 6, wherein
the power supply means includes an electromagnetic coupling section that produces the driving electric power from an electromagnetic wave supplied from the outside in accordance with the principle of electromagnetic induction.

8. The interactive image acquisition device according to claim 6, comprising:
wireless transmission means for wirelessly transmitting the images captured by the image pickup elements; and
image receiving means for receiving the images wirelessly transmitted from the wireless transmission means, wherein
the images received by the image receiving means are supplied to the image connection means under the situation that the image pickup elements and the wireless transmission means are placed in a spherical or cylindrical capsule housing.

9. The interactive image acquisition device according to claim 6, comprising:
wireless transmission means for wirelessly transmitting a specification signal that indicates the target object specified by the target specification means; and
specification signal receiving means for receiving the specification signal wirelessly transmitted from the wireless transmission means, wherein
the specification signal received by the specification signal receiving means is supplied to the image connection means under the situation that the image pickup elements and the wireless transmission means are placed in a spherical or cylindrical capsule housing.

10. The interactive image acquisition device according to claim 6, comprising:
temporary storage means for temporarily storing the connection image connected by the image connection means in the form of a still image;
identification information storage means for storing identification information of the image pickup elements that output the images constituting the connection image; and
current arrangement calculation means for tracking, when the target object is specified by the target specification means from the connection image read out from the temporary storage means, how the temporarily-stored connection image and the connection image currently acquired from the image pickup elements corresponding to the identification information move over time in order to calculate the current arrangement of the specified target object, wherein
the target object is specified by the target specification means from the connection image that the temporary storage means temporarily stores in the form of a still image and the image processing means calculates the positional correlation of the current images in accordance with the current arrangement.

11. The interactive image acquisition device according to claim 6, wherein:
the target specification means specifies a plurality of target objects; and
the image processing means calculates the positional correlations between the images captured by the image pickup elements and the specified target objects.

12. An interactive image acquisition device comprising:
a plurality of image pickup elements that are placed at a predetermined place to be observed and are arranged so as to take images of different directions such that the images captured by at least two or more image pickup elements are partially overlapped with one another;
image connection means for connecting the images captured by the image pickup elements;
target specification means for specifying a desired target object from the image captured by the image pickup elements; and
image processing means for calculating a positional correlation between a connection image that the image connection means produced by connecting the images and the target object specified by the target specification means and arranging the target object substantially at the center of the connection image in accordance with the positional correlation.

13. The interactive image acquisition device according to claim 12, comprising
transmission means for transmitting, when no target object is specified by the target specification means, all the images constituting the connection image to a predetermined information processing device.

14. An interactive image acquisition method comprising:
an image connection step of connecting images captured by image pickup elements that can move in a space and are arranged so as to take images of different directions such that the images captured by at least two or more image pickup elements are partially overlapped with one another;
a target specification step of specifying a desired target object from the image captured by the image pickup elements;
a positional correlation determination step of calculating a positional correlation between a connection image that the image connection step produced by connecting the images and the target object specified by the target specification step; and
an image processing step of arranging the target object substantially at the center of the connection image in accordance with the positional correlation calculated by the positional correlation determination step.
